(19) United States
(12) Patent Application Publication
(10) Pub. No.: US 2012/0046146 A1
(43) Pub. Date: Feb. 23, 2012

(54) Novel Climbing Wall

(76) Inventors: Chris Roberts, Fort Collins, CO (US); Paul Dusatko, Fort Collins, CO (US)

(21) Appl. No.: 13/136,476

(22) Filed: Aug. 1, 2011

Related U.S. Application Data
(60) Provisional application No. 61/369,594, filed on Jul. 30, 2010.

(51) Int. Cl. A63B 9/00; B23P 11/00

(52) U.S. Cl. 482/37; 29/428

(57) ABSTRACT

The inventive technology, in at least one embodiment, may be described as a climbing wall structure exhibiting a novel shape, where a ramped section may smoothly transition to an overhanging section via the use of straight support members that are angularly offset, relative to adjacent support members, and warped surface panels attached thereto. Corners, such as ramped and/or overhanging corners, may be incorporated as part of the wall.

### CROSS-REFERENCE TO RELATED APPLICATION(S)

This is a non-provisional patent application that claims benefit of and priority to U.S. Provisional application 61/369,594, filed Jul. 30, 2010, entitled “Novel Climbing Wall and T-Nut Washer”, said provisional application incorporated herein in its entirety.

### BACKGROUND

Artificial wall climbing (i.e., climbing on man-made structures) has boomed in popularity in recent years. On artificial walls with removable holds, perhaps climbers find most appealing is the opportunity to climb different routes (or different boulder problems, as the case may be) on the same wall, over time. Continual replacement of “old” routes or problems with new ones on the same wall gives a climber a chance to climb at different levels, requiring different moves, in the same location. Setters of routes or problems can customize a route or problem to address a specific aspect of climbing ability (e.g., endurance), or require a particular move (e.g., a drop knee) as an isolated training technique. The controlled setting of artificial climbing walls (particularly when the wall is indoors) allows for climbing when climbing on natural rock in the natural environment may be inconvenient, impractical, or virtually impossible (e.g., due to darkness or inclement weather). The convenience afforded by artificial climbing walls located in, e.g., urban settings, allows many climbers to get a quick climb in without having to travel far and hike to a natural climbing crag. The controlled environment of an artificial climbing wall, and the ability to mitigate risk of injury to climbers—whether by providing soft landings through cushioned flooring or “crash pads”, by improving lead climb safety by allowing for facile readjustment of bolts for lead climbing when necessary (and by allowing for facile replacement when damaged or strength compromised), or by enhancing safety via ready dissemination, and enforcement, of climbing safety rules—has attracted many aspiring beginners that otherwise would never have climbed. For these reasons, in addition to the fact that artificial climbing walls tend to be great social venues, artificial climbing walls have proven to be increasingly popular in more recent years.

As such, much effort has been focused on design of climbing wall and climbing holds. Whereas the first artificial walls tended to be planar in large sections, perhaps with different sections having different relative orientations (e.g., one 20′×20′ section might face due south have a first angle relative to horizontal, while an abutting 20′×20′ section might face due south might be vertical, and another abutting 20′×20′ section might be vertical, facing southwest), more recent designs have often attempted to mimic natural rock, featuring the irregularities in surface texture, shape and orientation found outdoors in the natural setting. Indeed, given that indoor climbing has become a training ground for climbing on natural rock, this progression in design did not come as a surprise.

However, as artificial climbing walls have attempted to mimic natural rock, their construction has increased in complexity. The underlying support for the irregular surface texture, shape and orientation of the wall must, at least roughly, approximate the outer shape, and must, of course, be strong enough to support a climber. Any bolts that are used (on lead climbing walls) must be anchored into a wall section that's strong enough to support a heavy climber's fall, which may easily amount to several hundred pounds of force. And as artificial climbing wall construction and design has become increasingly more complex, associated costs have increased dramatically.

Some climbers—particularly those that are interested in serious technical training in which climbing/bouldering moves are isolated and repeated—have noted that, at times, it seems as though some of the features of artificial climbing walls that attempt to mimic natural rock walls—small alcoves, bulges, dihedrals, e.g.—tend to compromise the ability to set customized training scenarios having wide application. Indeed, a climber wanting to increase her crimper strength and endurance for a variety of degrees of steepness (pitch) might have a difficult time finding such training on a highly irregularly featured artificial wall.

What would be ideal for such a climber would be a wall that, while presenting the non-planar, warped features found so often in natural rock discards those irregularities that, while certainly found at times in natural settings, seem to be disproportionately represented in artificial walls that mimic natural rock—small alcoves, bulges, dihedrals, e.g. Such a wall, in providing a wide breadth of possible training regimens and scenarios for square footage of climbing wall, would be a highly efficient training wall, and would be popular not only with focused climbers interested in a concentrated, progressive, easily adjusted training regimen, but also with climbing gym managers interested in maximizing their use of a limited space.

The inventive climbing wall, in embodiments, also addresses the problem of limited overhanging training wall terrain so common among conventionally known bouldering “caves” that are surrounded on one or more sides with vertical walls. These walls are accessible to climbers on much of the overhung terrain, and as such, compromise training opportunities by providing a tempting—and easily accessible—vertical surface that any struggling climber can “throw” a foot onto, thereby “backing off” a challenging climb or boulder problem; a climber without such an option will be forced to complete the move, or fall, and will improve that much more quickly. The vast majority (at the least) of steeper than vertical climbing surface of certain, preferred embodiments of the inventive climbing wall is well away from any surface that a climber might use to “back off” a bouldering problem. Just another feature pointing to the efficiency of the wave shaped wall.

Another attractive feature of certain embodiments of the inventive technology is its provision of slab climbing surface (i.e., less than vertical) on one side, and very steep terrain on the other. As such, novice or perhaps even physically impaired climbers can work on boulder problems on a section of wall that transitions into some of the hardest artificial wall terrain in existence. As such, it is expected that particular embodiments of the inventive technology will bring climbers of all ages and abilities together in one general area of a climbing center—a great draw for climbing gyms, and so different from so many gym layouts that tend to segregate climbers according to ability.

Such an ideal training wall—i.e., one that features a pitch that gradually, flowingly changes (e.g., in wave or warped fashion) from one side to the other—would, at least to one of ordinary skill in climbing wall construction and design, appear to still require expensive construction techniques and materials to achieve the curving, warped contour. But in conceiving a novel construction technique to achieve a curved wall from only planar paneling and straight support members, the inventor of the technology disclosed herein has avoided the high costs that would otherwise be expected.

What is particularly surprising and unexpected about particular embodiments of the inventive technology disclosed herein is the provision of an overall non-planar artificial climbing surface through the use of planar and straight building materials. Such is one reason why such embodiments feature relatively low design and construction costs, which is particularly unexpected given the incorporation into such embodiments of feature of non-planarity, skew, and/or warp found so often in natural rock walls—and one that conventional construction techniques used with artificial walls that replicate natural features could achieve only at great cost. Indeed, one goal of at least one embodiment of the inventive technology is to provide a wall that avoids the need for complex construction techniques and materials so common in today's era of construction of artificial walls to mimic natural rock, and avoids the costs associated therewith, while still mimicking the non-planarity and warp found in natural walls and while providing an enhanced training wall experience for climbers.

Another broad goal of the inventive technology is to efficiently use space by providing a climbing wall that, with its varied, gradually changing pitch, is amenable to a wide variety of training regimen in a relatively compact space, and with a limited amount of wall are. Indeed, a climber interested in becoming increasingly stronger on the same size crimper hold may, progressing from one side to another on the wall over time, gradually increase the steepness of his daily training regimen.

Another broad goal of the inventive technology is to provide a variety of climbing wall featuring a gradually and flowingly changing pitch from one side to the next—without the high construction and design cost or complexity endemic of artificial walls that seek to mimic natural rock walls.

Another distinct aspect of the inventive technology relates to T-nut washers used to secure climbing holds to the climbing wall surface. As a brief explanation, climbing holds, and lead climbing bolts, are often secured using a t-nut. And because both climbing holds and lead climbing bolts are subjected to significant forces, the substrate material in the area of the central hole through the underlying substrate (plywood, for example, through which the T-nut is bolted) may become worn, frayed and compromised. Indeed, the relatively small expanded head of the T-nut allows for the generation of significant leverage and torque under applied force—leverage and torque that can cause movement of the T-nut relative to the substrate/paneling (and even movement of the substrate in the area of the central hole relative to the rest of the substrate). Such movement can compromise the substrate (the climbing surface panels such as plywood) in the area of central hole and thus, compromise the strength of the attachment. Also, the annular base of the t-nut may become compromised itself (perhaps it becomes crushed and deformed), compromising the purchase of the t-nut on the paneling substrate. Further, replacement of climbing holds may involve removal and replacement of the T-nut into the same central holes; whether or not the same T-nut attachment holes are used or not, replacement alone may compromise integrity of the substrate in the area of the pilot hole. At times, due to repeated and continued use of the same t-nut, whereby the screws which secure the t-nut to the back of the substrate “wallow out” their pilot holes and damage the back of the substrate, a T-nut may even fail. At such point, the T-nut is no longer able to be attached for functional use. Regardless, the t-nut would benefit from either total replacement with an new improved t-nut, or a new t-nut retrofit method that resolves one or more of the above problems.

A goal of an embodiment of the inventive T-nut related technology is the provision of a retrofit washer that can be used to preclude the need for other more drastic remedial action in the event where substrate in the are of the T-nut attachment has become frayed or otherwise compromised, or the t-nut has been compromised itself. Indeed, the retrofit T-nut washer can avoid the need to remove the T-nut permanently, or repair the substrate. As such, the retrofit T-nut washer can save significant repair costs.

A goal of an embodiment of the inventive T-nut related technology is provision of a retrofit washer that can be used relative to a new or pre-existing T-nut attachment to increase the strength of the attachment.

A goal of an embodiment of the inventive T-nut related technology is provision of an expanded T-nut that has provides a stronger, more durable attachment, and one that causes less damage to substrate in the area of the T-nut attachment.

Of course, other goals and advantages of the inventive technology are disclosed elsewhere in the specification.

### BRIEF DESCRIPTION OF THE DRAWINGS

FIGS. 1A and 1B show left and right view diagrams of an embodiment of the inventive climbing wall.

FIG. 2 shows a front view diagram of the embodiment of the inventive climbing wall.

FIG. 3 shows a rear view diagram of the embodiment of the inventive climbing wall.

FIG. 4 shows a top plan view diagram of the embodiment of the inventive climbing wall.

FIG. 5 shows a bottom view diagram of the embodiment of the inventive climbing wall.

FIG. 6 shows a cut-away perspective view diagram of the embodiment of the inventive climbing wall.

FIG. 7 shows a cut-away perspective view from under the prow of the embodiment of the inventive climbing wall.

FIG. 8 shows an overhead, perspective view photograph of a model of an embodiment of the inventive climbing wall.

FIG. 9 shows a rear overhead view photograph of a model of an embodiment of the inventive climbing wall.

FIG. 10 shows an overhead, front perspective view photograph of a model of an embodiment of the inventive climbing wall.

FIG. 11 shows a left side photograph of an embodiment of the inventive climbing wall (before final completion).

FIG. 12 shows various views of an embodiment of the inventive climbing wall.

FIG. 13 shows a rail layout sketch of an embodiment of the inventive climbing wall.

FIG. 14 shows plans for an embodiment of the inventive climbing wall.

FIG. 15 shows plans for an embodiment of the inventive climbing wall.

FIG. 16 shows an exemplary building incorporating and of the embodiment of the inventive wall technology.

FIG. 17 shows an exemplary building incorporating and of the embodiment of the inventive wall technology, with landscape features.

FIG. 18 shows a top view of an embodiment of the inventive climbing wall structure established between two conventional vertical walls.

FIG. 19 shows a rear view of an embodiment of the inventive climbing wall structure established between two conventional vertical walls.

FIG. 20 shows a side view (from a first side) of the straight support members in embodiments having a ramped and overhanging section on either side of a thin “dead” vertical section.

FIG. 21 shows a side view (from a second side) of the straight support members in embodiments having a ramped and overhanging section on either side of a thin “dead” vertical section.

FIG. 22 shows a perspective schematic of an embodiment of inventive climbing wall structure established between two conventional vertical walls.

FIG. 23 shows an aerial plan view of a four-faced, free-standing, island type climbing wall structure. The upper right and lower left portions are ramped corners while the remaining two corners are overhanging prows.

FIG. 24 shows a first side view (elevation) of a four-faced, free-standing, island type climbing wall structure.

FIG. 25 shows a second side view (elevation) of a four-faced, free-standing, island type climbing wall structure.

FIG. 26 shows a view from a corner of a four-faced, free-standing, island type climbing wall structure.

FIG. 27A shows a side view of warped surface panels attached to two straight support members.

FIG. 27B shows a single, planar, discrete surface panel from the front and its view from a side.

FIG. 27C shows an example of a single, discrete, warped surface panel, as attached to straight support members, from the front and its view from a side; the side perspective shows projections in a vertical plane that is orthogonal to the base plate. The side view of FIG. 27C shows how right and left edge portions are angled relative to each other when viewed from the side. It should be understood that this is merely one possible warped pattern, and that warping has been exaggerated for illustrative purposes.

FIG. 27D shows how upper and lower edge portions of an exemplary warped panel (attached to straight support members) are angled relative to each other when viewed from above. It should be understood that this is merely one possible warped pattern, and that warping has been exaggerated for illustrative purposes.

FIG. 28A shows a plan view of an embodiment of a t-nut attachment that uses the inventive washer, in an embodiment.

FIG. 28B shows a side view of an embodiment of a t-nut attachment that uses the inventive washer, in an embodiment.

FIG. 28C shows a view from the underside of the system of FIG. 29B.

FIG. 29 shows a view of an embodiment of a t-nut attachment that uses the inventive washer, in an embodiment.

FIG. 30A shows a view of an embodiment of a t-nut, as attached, that integrally incorporates the inventive washer, in an embodiment.

FIG. 30B shows a side view of an embodiment of a t-nut, as attached, that integrally incorporates the inventive washer, in an embodiment.

FIG. 30C shows a view from the underside of the system of FIG. 31B.

FIG. 31 shows a view of an embodiment of a t-nut that integrally incorporates the inventive washer, in an embodiment.

FIG. 32A shows a side view of an embodiment of a t-nut attachment that uses the inventive washer, in an embodiment.

FIG. 32B shows a side cross-sectional view of an embodiment of a t-nut attachment that uses the inventive washer, in an embodiment.

FIG. 33A shows a side view of a t-nut in operational correspondence with the inventive washer, in one embodiment, with arrows showing bolt or screw passage directions.

FIG. 33B shows a perspective view of an embodiment of the inventive washer in attached configuration, relative to a t-nut (underlying substrate and screws or bolts are not shown).

FIG. 33C shows a view (from the underside of FIG. 34B) of an embodiment of the inventive washer in attached configuration, relative to a t-nut (underlying substrate (such as plywood) and screws or bolts are not shown).

FIG. 34A shows a conventional t-nut in side view.

FIG. 34B shows a conventional t-nut in perspective view.

FIG. 34C shows a conventional t-nut, from the underside of FIG. 35B.

FIG. 35A shows a side view of an embodiment of the inventive t-nut washer technology.

FIG. 35B shows a perspective view of an embodiment of the inventive t-nut washer technology.

FIG. 35C shows an under or top-side view of an embodiment of the inventive t-nut washer technology.

FIG. 36 shows a cross-sectional side view of an embodiment of the inventive t-nut washer that integrally incorporates an expanded washer.

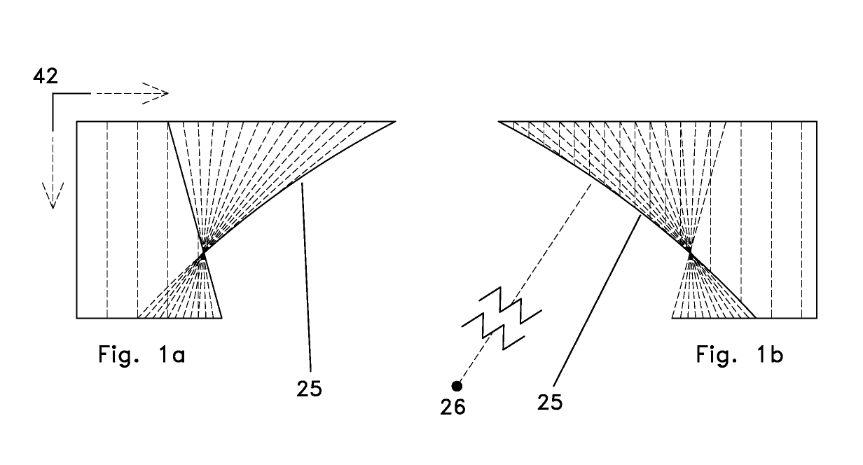

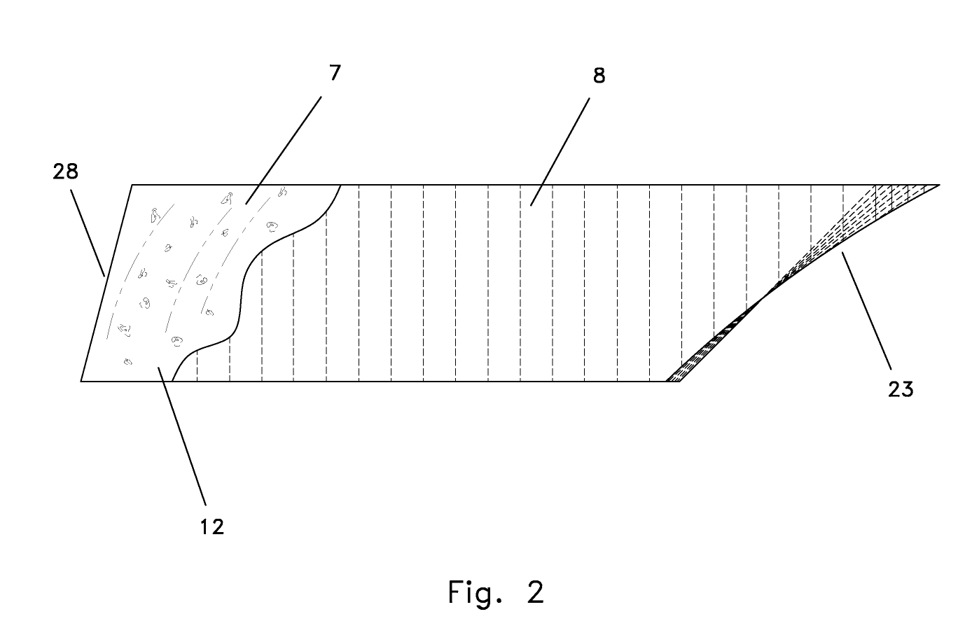

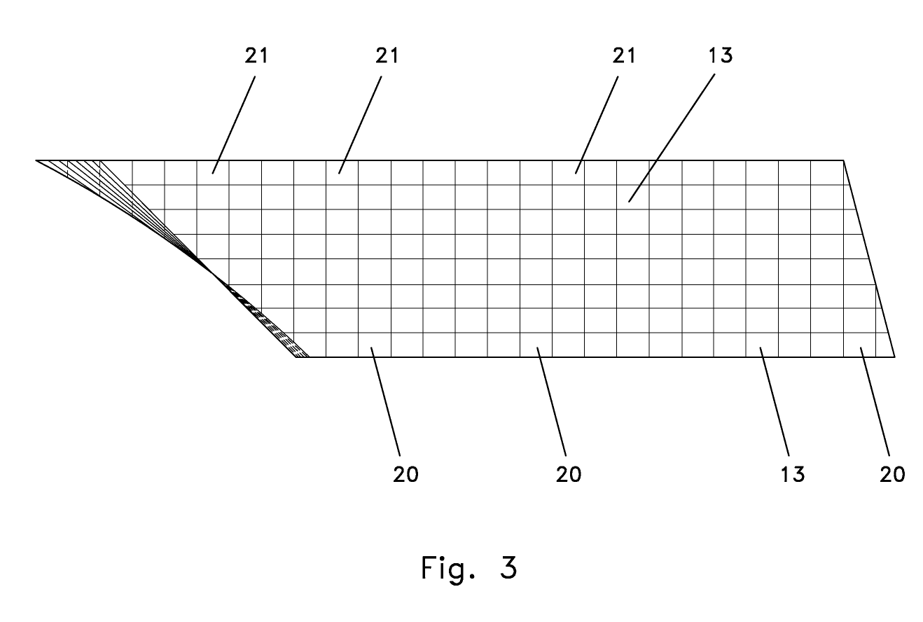

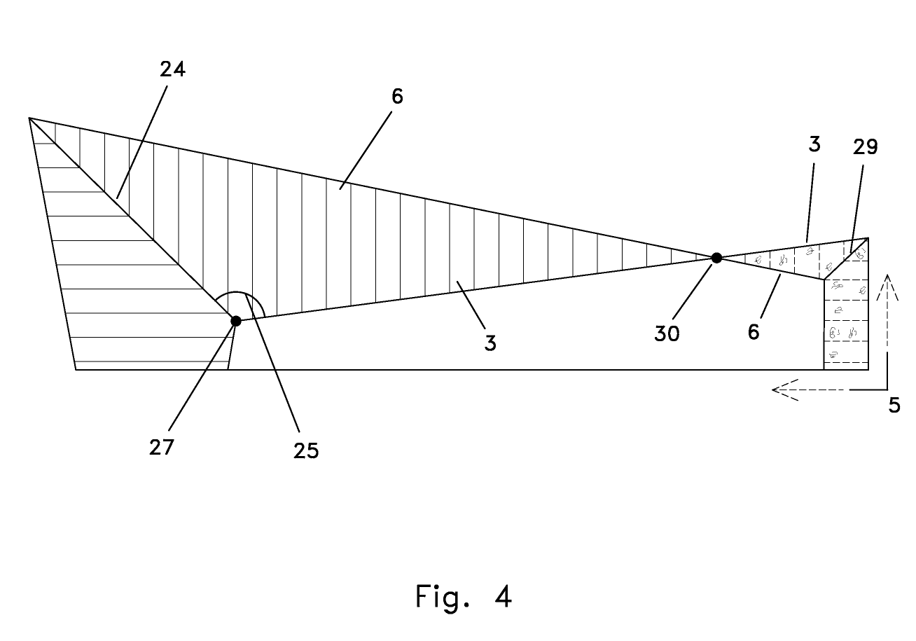

### DETAILED DESCRIPTION OF THE INVENTIVE TECHNOLOGY

As mentioned earlier, the present invention includes a variety of aspects, which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

In at least one embodiment, a wave is formed in this climbing structure through the use of straight structural members for top and bottom plates. These plates are typically skewed with respect to each other (such that their projections in a horizontal plane are angled relative to each other); upon securing straight support members (a straight support member may be wood 2×4's, as but one example; they may possibly, but certainly not necessarily, be joined at ends to achieve the desired length) from the bottom plate to the top plate, and attaching surface panels (e.g., plywood) to the straight support members (and usually to the top and bottom plates also), a structure of varying degrees of pitch (steepness) of climbing surface is formed. The straight support members are used to provide backing for the wall surface, which allows for the climbing holds to be attached. Straight support members may be wood, or other sufficiently strong material (e.g., steel, as but one example). The climbing hold support surface, as mentioned, may comprise paneling (e.g., plywood sheeting, or sheeting of other sufficiently strong material); texturing material may be applied over the sheathing for a more natural rock appearance and feel. The possible surface angles are only limited to the warping abilities of the paneling, and/or the configuration of the structure (either vertical, horizontal or some varying degree therebetween, whether overhanging or ramped).

In at least one embodiment of the inventive technology, a warped, wave-like structure (whether for climbing or other purposes) is constructed from entirely straight support members and planar paneling. Typically, during construction, support members are situated so that they each extend from a bottom plate (perhaps resting on a supporting floor) to a top plate. Neither the top nor the bottom plate need be horizontal, but, when viewed from above (i.e., such that one is observing their projections in a horizontal plane), they would define axes that are angled relative to each other. Straight support member location may depend on the application (e.g., if indeed a climbing wall is to be constructed, strength of support must be considered) and whether efficient use of support member material is a goal, among other things. Of course, where wall strength is at issue (e.g., in a climbing wall application), more straight support members will be necessary as compared with the case where the wall does not bear a load. At the very least, where paneling is used, such that there are “n” columns of panels (from one side to the other), then there must be at least “n−1” straight support members (where the far left edge of the far left panel column and the far right edge of the far right panel column are supported by something other than straight support members, such as corner supports).

Thickness of the paneling used for the climbing hold support surface may be governed by strength considerations, and whether the required degree of warpage for each panel compromises the integrity and strength of the panels. Where the requisite warpage for each panel does compromise the integrity and strength of the panels (where the panel simply cannot be warped as necessary, or where warping the panel as necessary would immediately compromise strength, or would expectedly compromise strength over time), a thinner, more pliable panel must be used. But where a panel that can be warped as necessary (i.e., without compromising strength or integrity) is so thin that it cannot provide the necessary support, the overall design, and the degree of warpage required in particular, must be re-considered and, eventually, attenuated. It is even possible in certain embodiments that the panels are entirely inflexible and remain planar upon being secured to the straight support members (i.e., they don't warp). In such a design, the warp is created only by the aggregate effect of several panels, each of which is entirely planar after being secured to the straight support members, but that defines a normal vector that is slightly offset from the normal vectors of one or all abutting panels. In such a case, so that the change in slope of the wall appears smooth, smaller panels may be advantageous.

In certain embodiments where efficient use of straight support members is preferred, and where the resulting structure meets design strength constraints, straight support members may be placed so that, at any point on the straight support member, a right edge portion of a panel to the left of the straight support member, and a left edge portion of a panel to the right of the straight support member each overly the straight support member (and are attached intermittently thereto at such portions). For example, in certain designs, where 4′×8′ panels (e.g., plywood panels) are used as the paneling material, and the panels are established such that the 4′ long edges are the top and bottom edges and the 8′ long edges are the side edges, straight support members may be placed every 4′, from left to right. Adjustments may be necessary (i.e., to slightly reduce the distance between straight support members), and can be made on site, to account for a slight change in horizontal width that may occur during warpage. Straight support members may each be progressively and incrementally (from one side to the other) steeper (such that their projections in a vertical plane that is orthogonal to the base plate are angled relative to each other; perhaps adjacent panels would be only slightly angled relative to each other). Where necessary for strength of support reasons, additional straight support members may be added at non-edge portions (e.g, ½ way between the ′4 offset straight support members) of the panels. If necessary, horizontal supports (whatever is used for the straight support members can also be used for the horizontal supports), which may represent “fireblocks”, can be secured between adjacent straight support members so that the upper and lower edge portions of lower and upper panels, respectively, can be attached to them.

Where possible, additional support may be provided by cable attachment between the straight support members and a sturdy structure overhanging the wall. In particular embodiments (particularly freestanding island, or peninsular, or opposing wall designs), support may be provided, at least in part, by opposing walls (e.g., with horizontal supports between opposing walls). It is of note that regardless of whether the face is part of a free-standing or building supported wall, in one preferred embodiment, when viewed directly from the side, and directly down the long axis of the base plate, the straight support members may appear to fan out in a non-intersecting pattern.

The shape is also well suited to be used in an architectural application the scale of which is only limited to structural materials available at the time of design and construction.

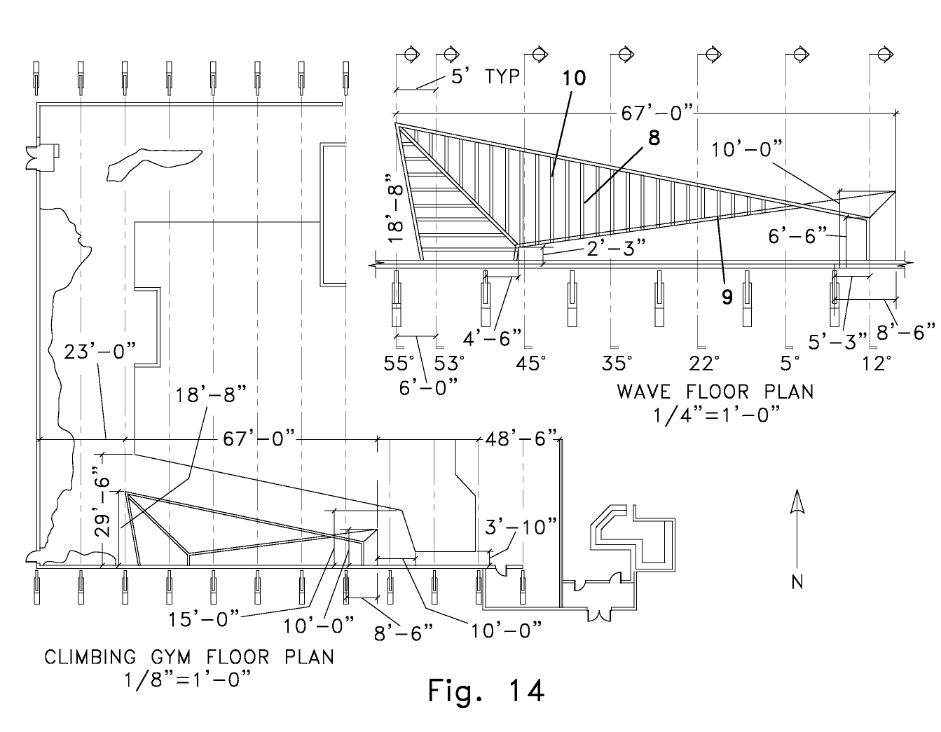

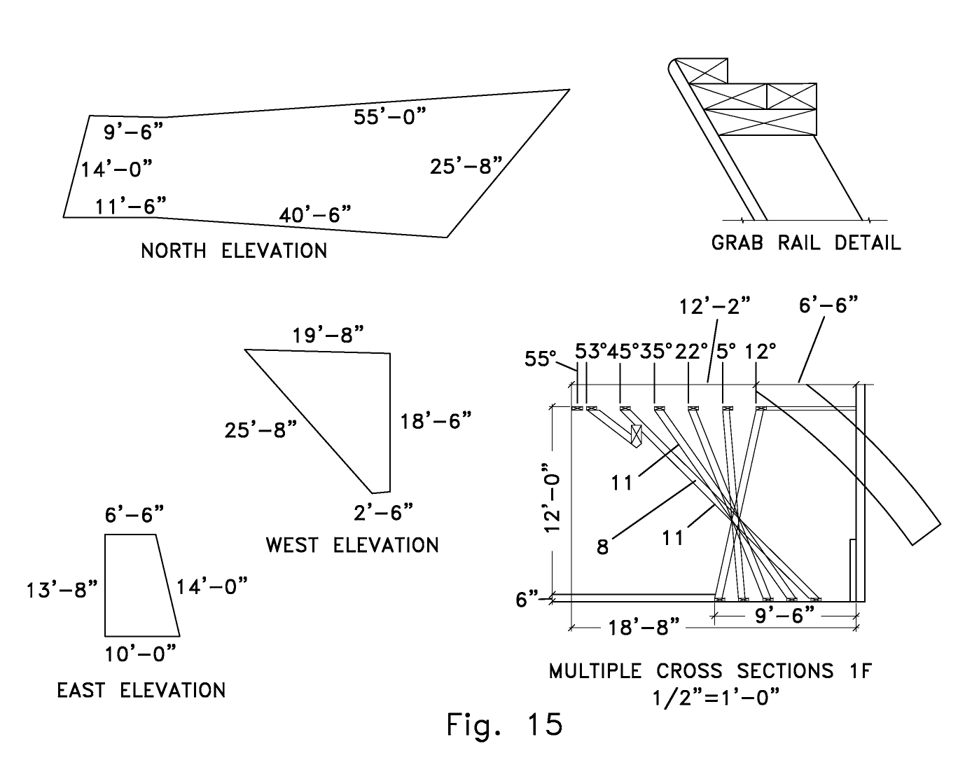

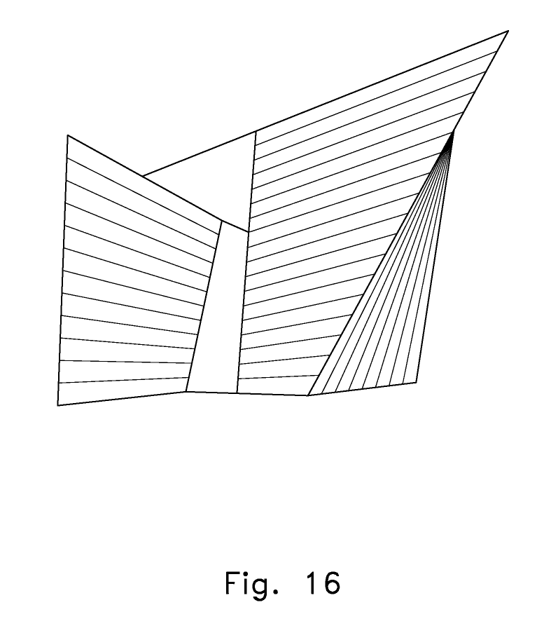

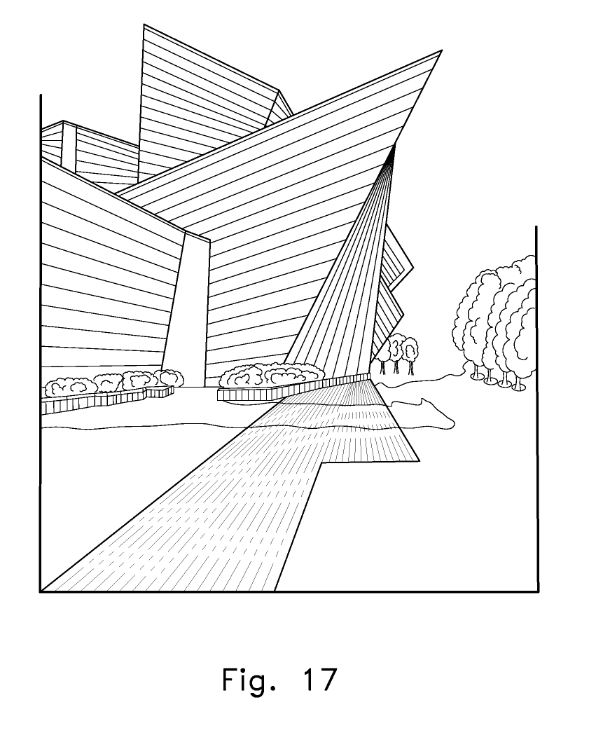

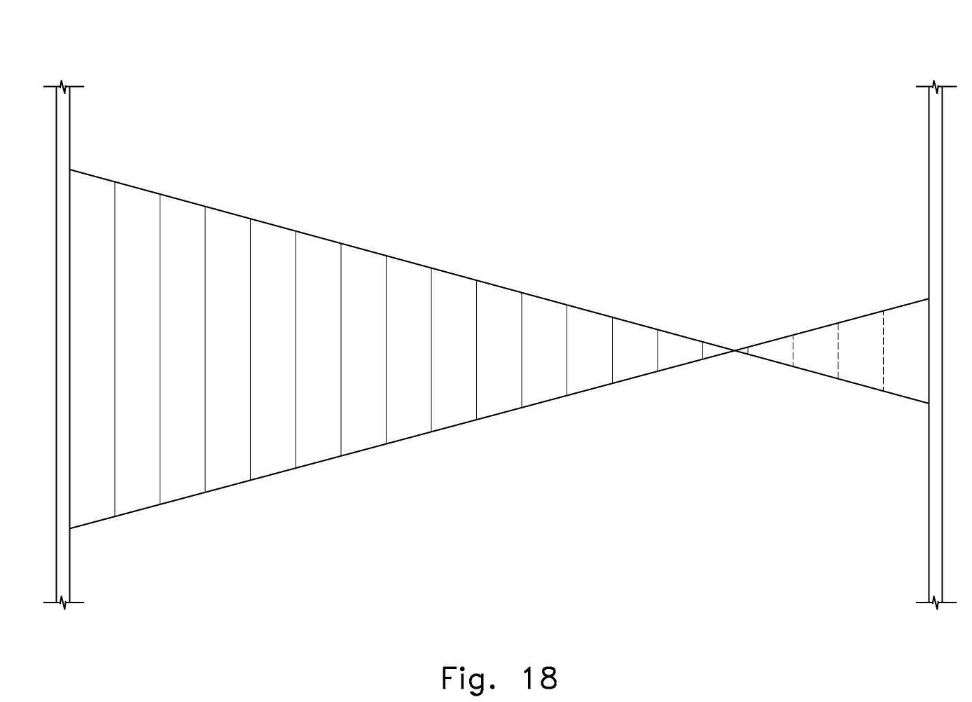

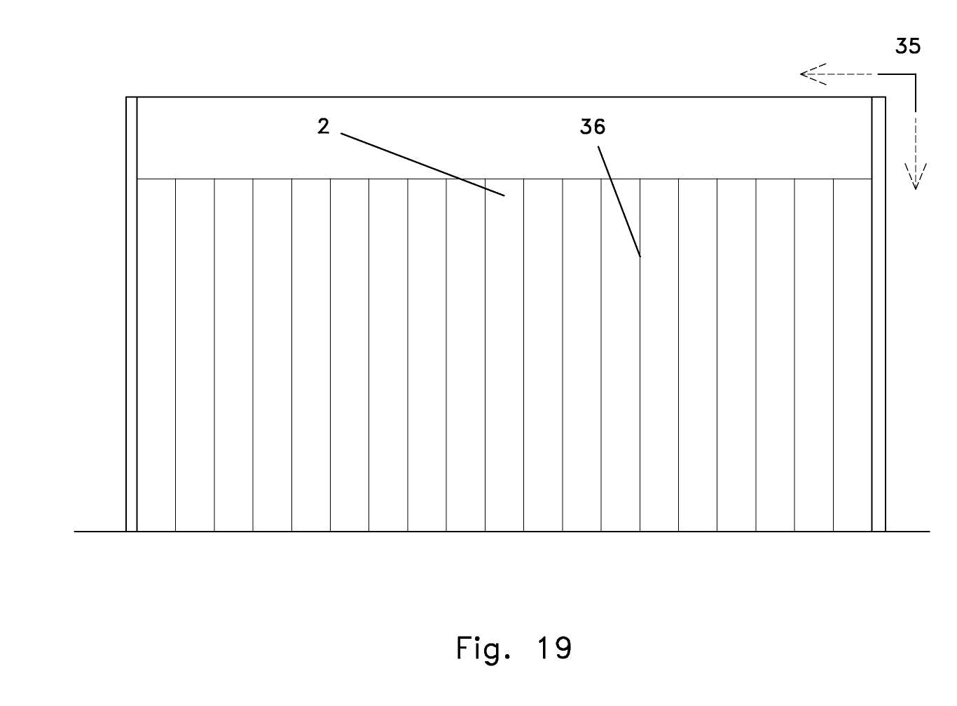

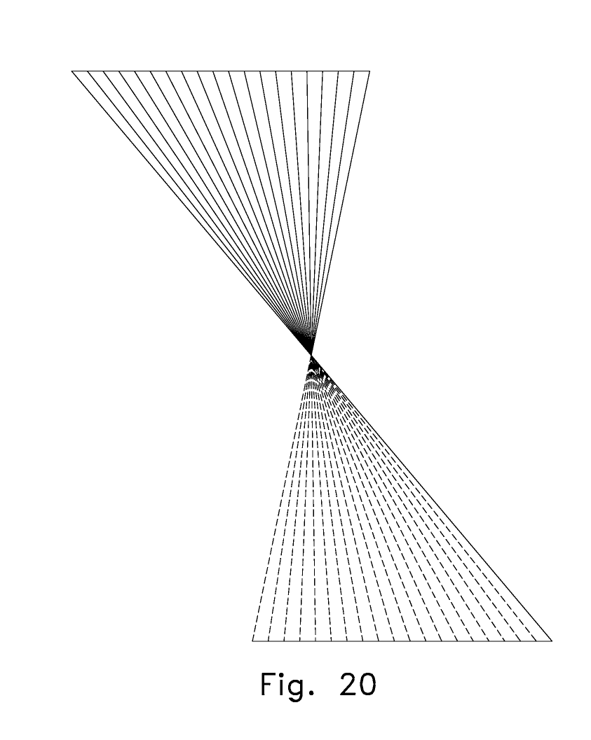

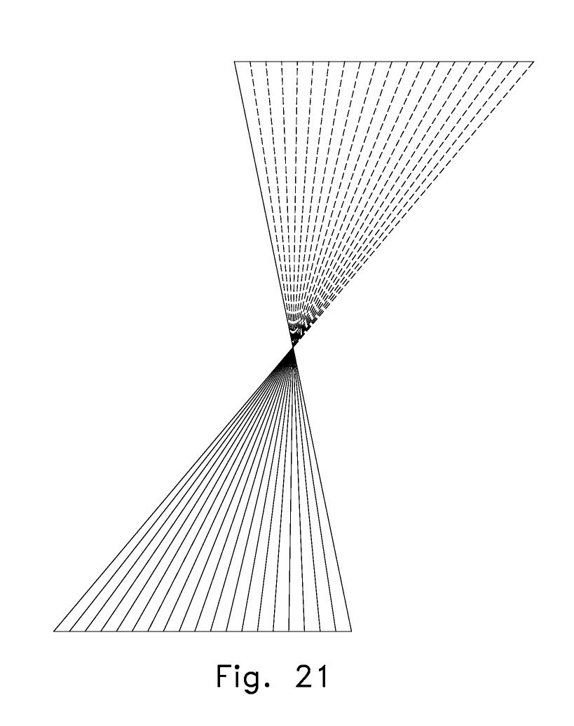

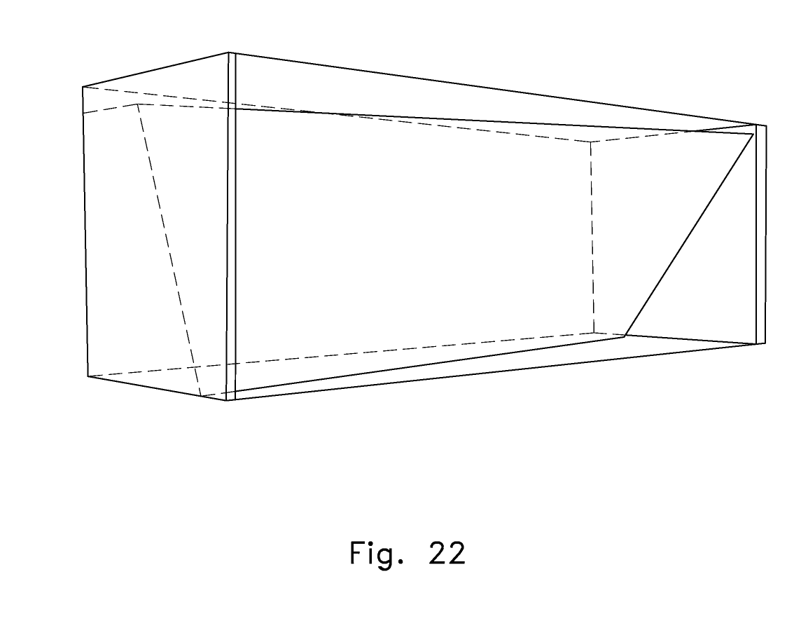

In one particular embodiment, as shown in FIGS. 14 and 15, a bouldering wall 12 feet in height, the wave allowed for climbing surface angles from 15 degrees from vertical, low slope slab to 55 degrees from vertical, overhanging, cave type, bouldering. Two corners (known to climbers as arêtes) have been included in this particular structure. One ramped corner starts where the main wall wave is 12 degrees from vertical, low angle slab, warping to 15 degrees at the bottom toe. The wall then turns for 10 feet at an approximate right angle to from a 15 degree, consistent (not warped) climbing surface. This adjunct or secondary wall need not have a change in incline from the ramped corner to its end but certainly may. This could be described as looking somewhat like a hip in roof structure terminology. The other corner (an overhanging prow, or overhanging arête) on the opposite end starts where the main wall wave warps to a vertical angle of approximately 47 degrees. This overhanging prow, having an average approximately 45 degrees between top and bottom plate, now accepts the bottom of the vertical members or straight support members. It continues in the same warped plane as the face to form an overhanging prow, similar to a ships prow. This same warped prow turns for 19 feet at an approximate right angle to the main wall and returns to a wall termination at an angle of approximately 43 degrees vertical. This adjunct or secondary wall need not have a change in incline from the ramped corner to its end but certainly may.

From this test case it is evident, using this warped plane as a basis, any angle or configuration can be achieved. The test case is a 3 sided structure backing to a vertical wall. This basic shape can also be utilized as a 4 or multiple sided structure to form a free standing structure (e.g., an island).

The test case is built as a horizontal structure with both the bottom plate and top plate being horizontal or level. Of course, this is not a requisite feature of the inventive technology. This is one reason why the claims reference projections of the top and bottom plates in a horizontal plane. The same basic shape can be structured with the main supporting members in a vertical orientation or any other orientation from horizontal to vertical depending on the desired effect.

A particular embodiment of the inventive technology may be described briefly as a ramped corner, an adjacent slab or ramp (i.e., where the angle is away from the climber) of the main wall (e.g., first face), which may be at any angle (e.g., 20 degrees off vertical), a prow on the opposite side of the climbing wall, which demarcates two steep overhanging sections (they may be at any angle, including but not limited to 45 degrees), and a smoothly transitioning intermediate section between the slab and the prow, said intermediate section assuming a wave-like, warp. In particular embodiments, the intermediate section may (but need not) resemble a portion of a spiral (e.g., one side of the center of the spiral) on its side.

At least one embodiment of the inventive technology may be described as a climbing wall structure (1), comprising: a bottom plate (2) that is straight and has a bottom plate projection (3) in a horizontal plane (5) (a nominal, conceptual plane which may be anywhere (e.g., above, below, or intersecting the wall); a top plate (4) that is straight and has an top plate projection (6) in the horizontal plane; and a first face substantially between the bottom plate and the top plate (in certain embodiments, the first face is the main face). In certain embodiments, the bottom plate projection in the horizontal plane may be angled relative to the top plate projection in the horizontal plane (i.e., they don't exactly overlie one another and they are not parallel). A majority of a plurality of straight support members (8) may each extend from the bottom plate to the top plate, each may be attached (via fasteners of any sort, such as nails, brackets, screws, etc.) at a lower support member end (10) thereof to the bottom plate and to the top plate at an upper support member end thereof, the straight support members each having an outer edge (11) (to which paneling may be attached to form the climbing hold support surface). It is of note that even something (e.g., a bottom plate) that is entirely level can have a projection in a horizontal plane (analogously, a vertical support member has a projection in a horizontal plane). As one can understand with basic trigonometry, a projection in a plane of a thing is the component of that thing in that plane. It is note that straight support members in the area of a corner may be attached at one end to a corner supports (instead of an upper end attached to a top plate and a lower end attached to a bottom plate).

The climbing hold support surface (12) of the first face may include a plurality of discrete, warped surface panels (13) (e.g., pieces of warped (even if only slightly warped) plywood) attached to the straight support members. The discrete warped surface panels (15) may be planar before attachment to the straight support members, and each may have an upper (16), lower (17), right (18) and left (19) edge portion. Each of a majority of the discrete, warped surface panels may be attached to two different of the straight support members at the right edge portion and the left edge portion of the discrete, warped surface panel (some discrete, warped surface panels, particularly those in the area of corners, may have a right or left edge portion attached to something other than the straight support members, such as the corner support). It is of note that the term majority means more than half and as used herein may include all of the referenced item/part. Further, use of the term majority in a first context and with regard to a first item/part may, but need not, be a different quantity as compared to a majority in a second context but with regard to the same first item/part.

In preferred embodiments, each of a lower portion (20) of the discrete, warped surface panels (such as the ones at the bottom of the face) may be attached to the bottom plate at the lower edge portions of the lower portion of the discrete, warped surface panels. Further, each of an upper portion (21) of the discrete, warped surface panels may be attached to the top plate at the upper edge portions of the upper portion of the discrete, warped surface panels. These attachments, however, are not a required feature.

The climbing wall structure may have two corners (22) at a left and right end of the first face (which may be the only face of the structure, or one of several faces). At least one of the corners may be an overhanging prow (23) at a first corner side of the first face. The overhanging prow may have a straight overhanging prow projection (24) in the horizontal plane, and a curved profile (25) when viewed by a climber standing centrally in front of the first face. The straight overhanging prow projection may define an obtuse angle relative to the bottom plate projection; the obtuse angle may have an overhanging prow projection angle vertex (27). The curved profile of the overhanging prow may be, in certain embodiments, a circular arc profile. A nominal center (26) of the curved profile may be lower (in elevation) than any point on the bottom plate. A curve in the profile of a corner may be observable by a climber standing, perhaps centrally, in front of a wall that the corner is adjacent; this curve may appear when the corner's projection (e.g., an overhanging prow projection) in a horizontal plane forms an angle that is other than 90 degrees (i.e., the angle is acute or obtuse) with the bottom plate projection (the vertex of this angle would be at the end of the bottom plate that may help form the lower end of the corner); the greater the difference of this angle from 90 degrees, the more pronounced the curve. It is of note that typically, adjacent portions of faces on either side of a single corner will both be overhanging or both be ramped (at least in the area of the corner; they may transition from, e.g., overhanging to ramped, further away from the corner). Further, at least one of the two corners may be a ramped corner (28) at a second corner side of the first face, the ramped corner having a straight ramped corner projection (29) in the horizontal plane. Generally, a corner can be ramped, overhanging, or vertical (and in certain embodiments, as where for a right corner the top and bottom plates both extend further to the right than does a point ½ up the corner, a single corner can be ramped (e.g., on the bottom half of the corner) and overhanging (e.g., on the top half).

In preferred embodiments, the bottom plate projection may intersect with the top plate projection, the intersection (30) defining a vertical wall portion (31) (which may be thin left to right) of the first face. The structure may have a ramped portion (32) on one side of the vertical wall portion and an overhanging portion (33) on the other side of the thin vertical wall portion. Projections (36) of a majority of the plurality of straight support members in a vertical plane (35) that is parallel the bottom plate may form a 90 degree angle with the bottom plate (2). It is of note that the term left, right, upper and lower as used herein are from the perspective of a person, e.g., a climber, standing in front of the relevant face (as if preparing to climb) and looking at it.

In preferred embodiments, the plurality of straight support members may be progressively longer from the vertical wall portion to a wall portion corresponding to the overhanging prow projection angle vertex (and perhaps also progressively longer from such vertical wall portion to a wall portion corresponding to the end of the top plate (e.g.) where the ramped corner starts). Further, a straight line (40) connecting a point on the ramped (or other) corner that is X percent up from the bottom plate to a point on the overhanging prow that is the X percent up (i.e., the same percentage) from the bottom plate may contact the climbing hold support surface of the first face at all points on the straight line.

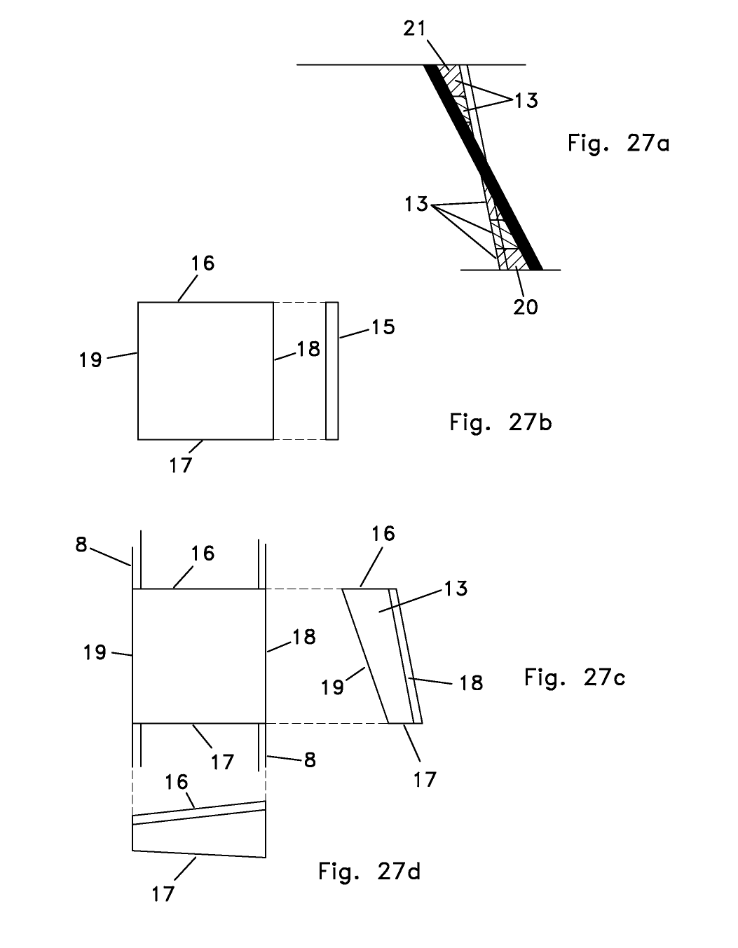

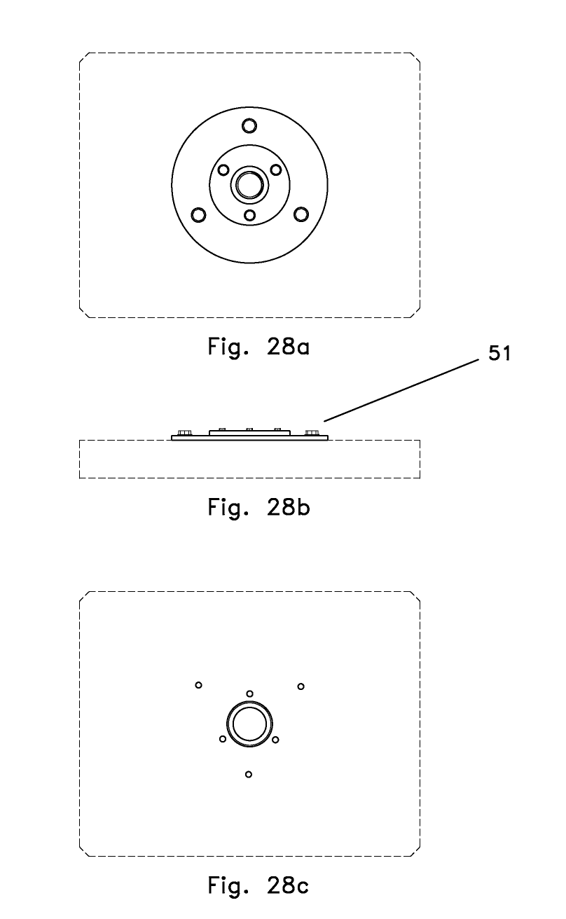

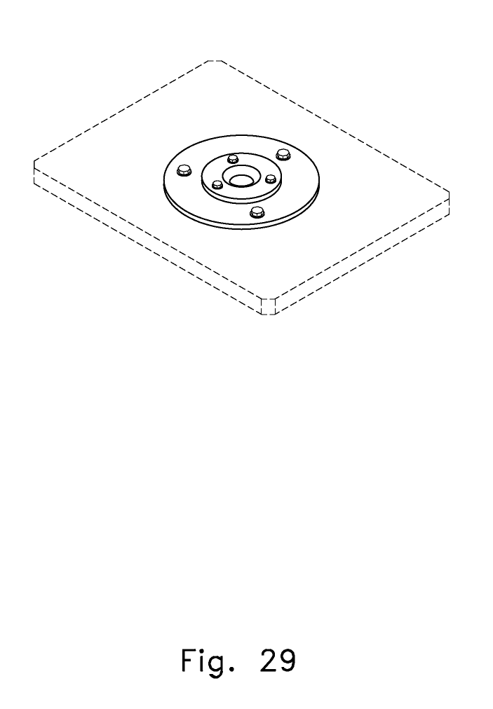

Further, projections in a vertical plane (42) that is orthogonal to the bottom plate projection, of the left and right edge portions of a each of a majority of the plurality of the discrete, warped surface panels, may be angled relative to each other (see FIG. 27C), and projections in the horizontal plane, of the upper and lower edge portions of a each of a majority of the plurality of the discrete, warped surface panels, may be angled relative to each other (see FIG. 27D).

It is also of note that projections in the vertical plane (orthogonal to the bottom plate projection) of a majority of the straight support members may be angled relative to each other. Projections in a vertical plane (35) that is parallel to the bottom plate of a majority of the plurality of straight support members may be parallel. Also, a majority of the plurality of straight support members may be spaced a substantially equal distance (such as a surface panel width).

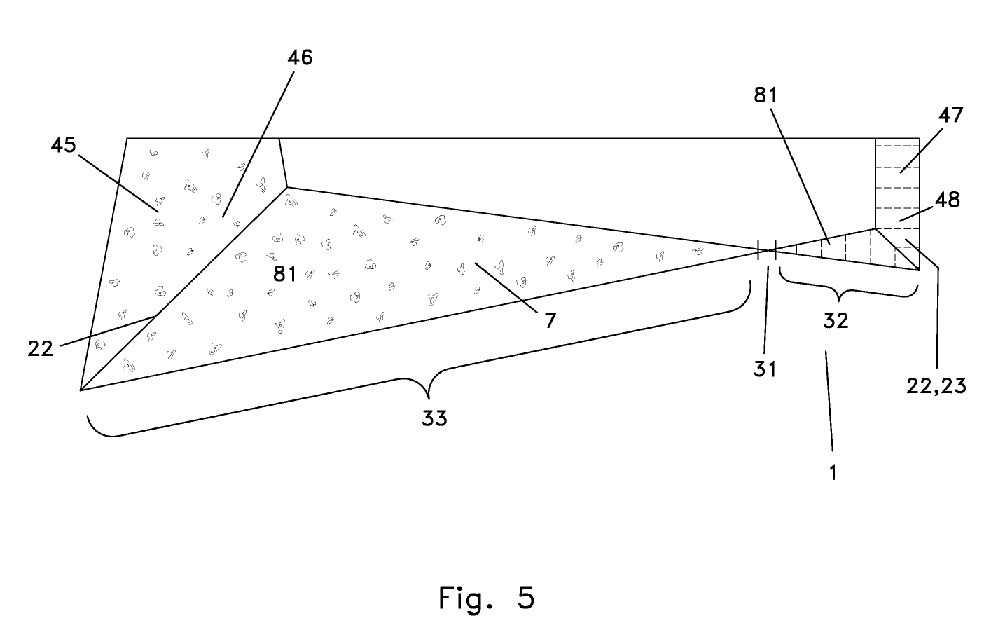

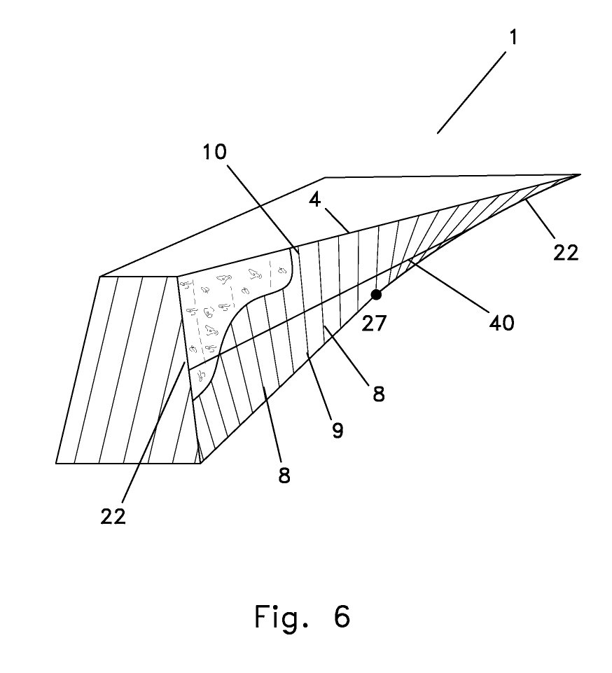

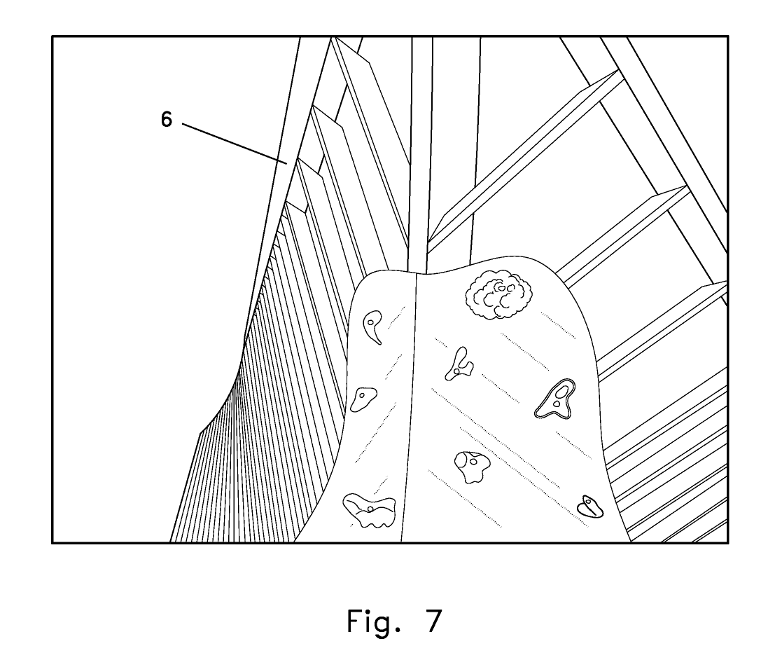

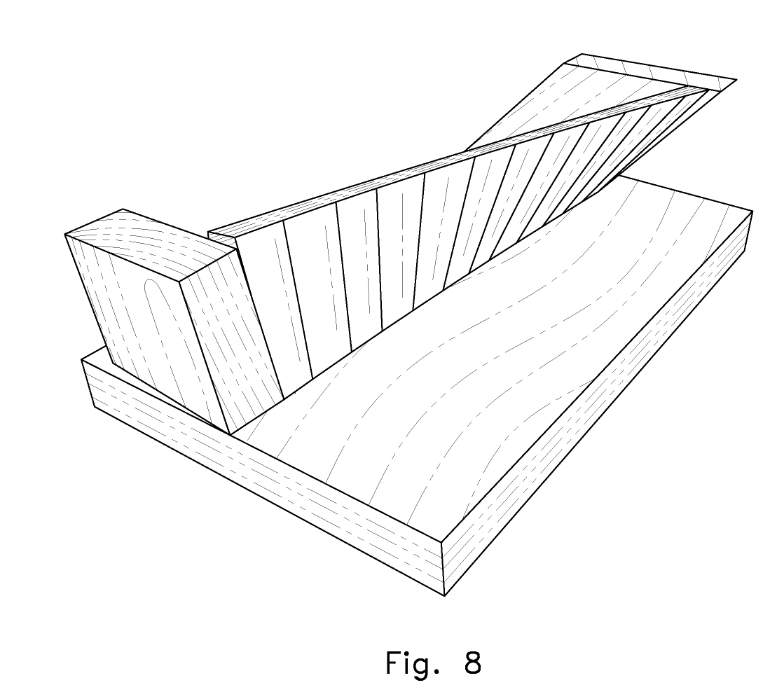

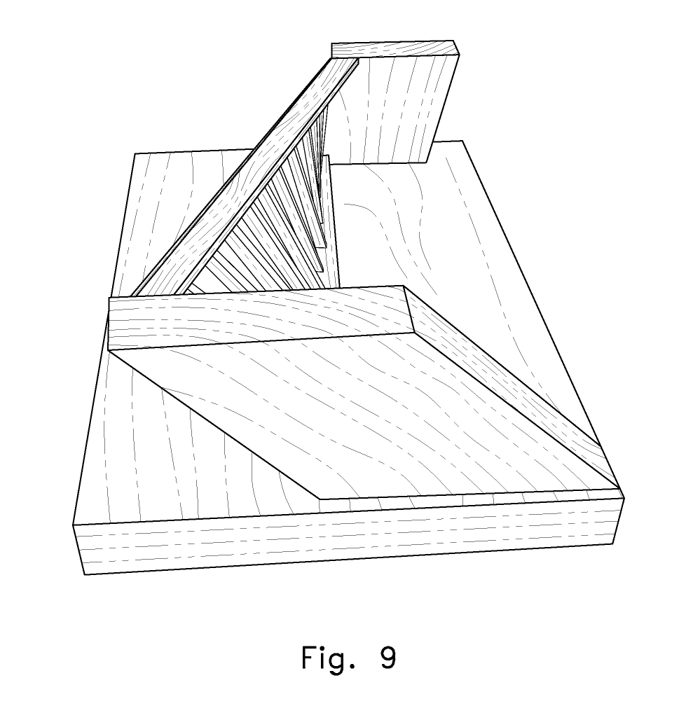

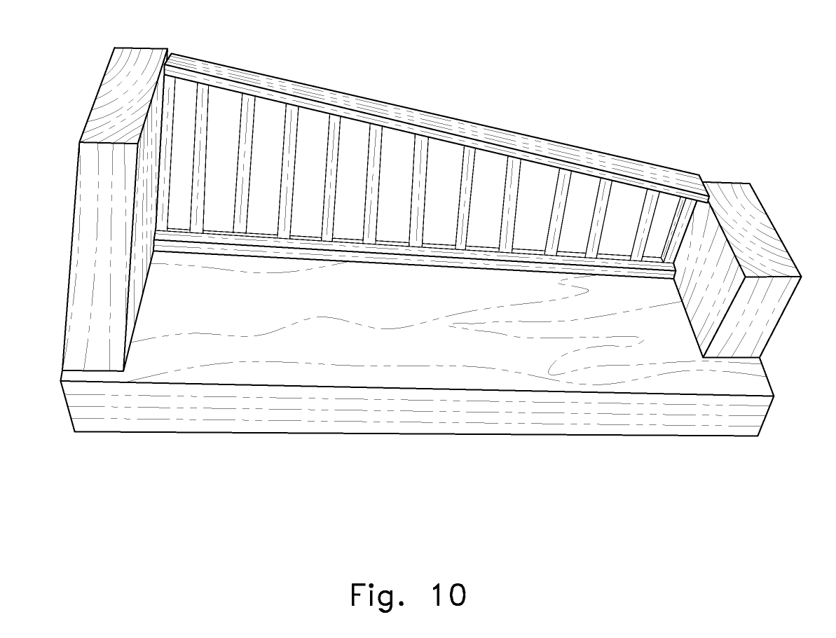

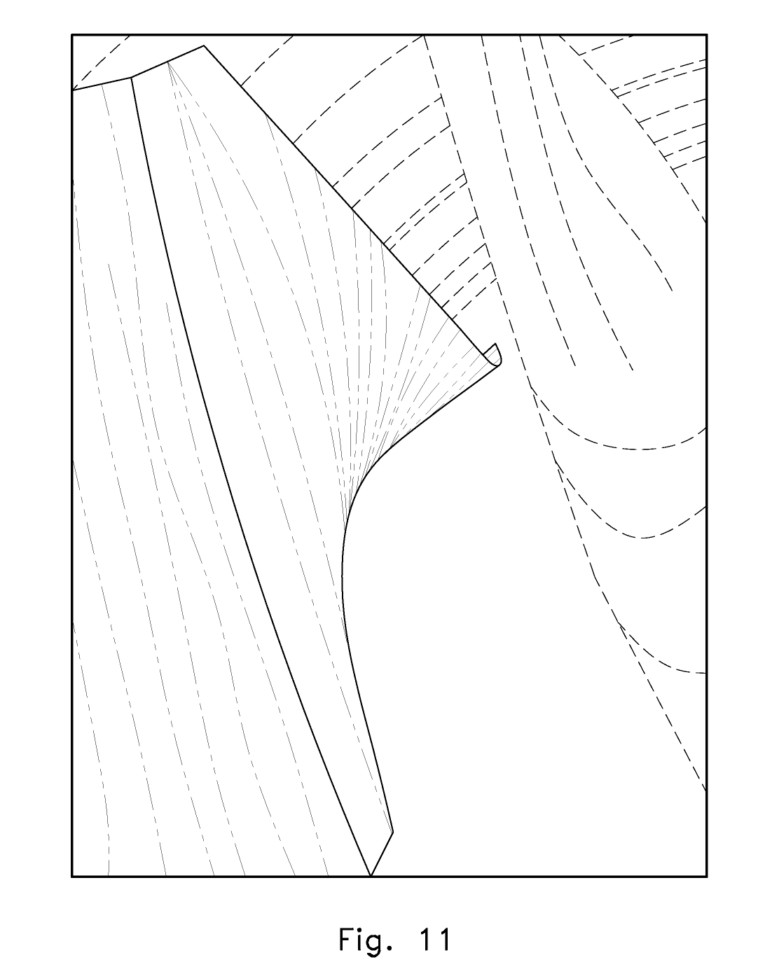

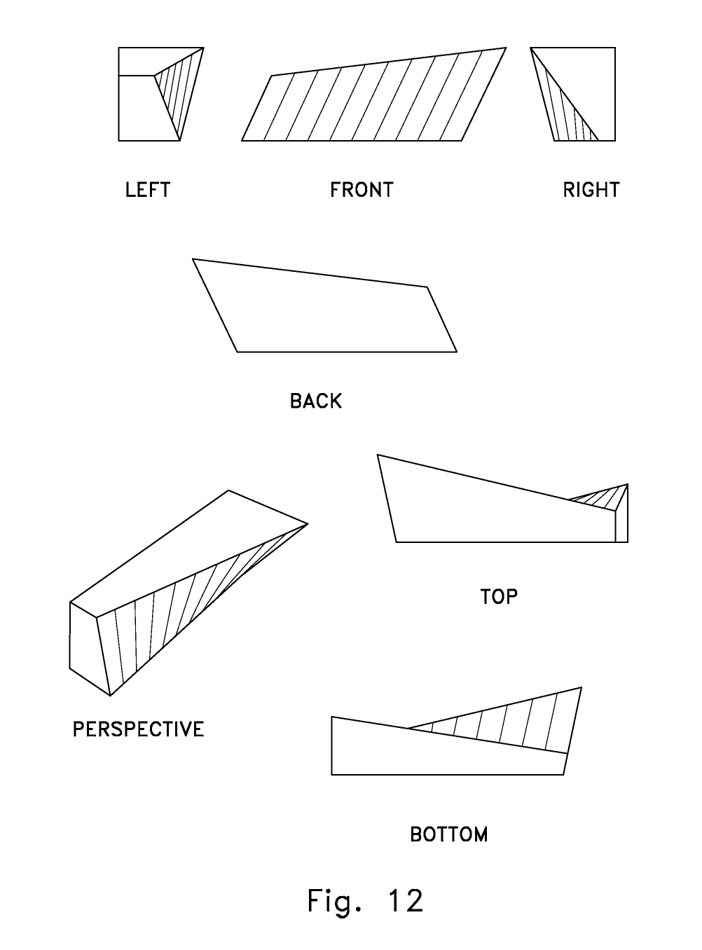

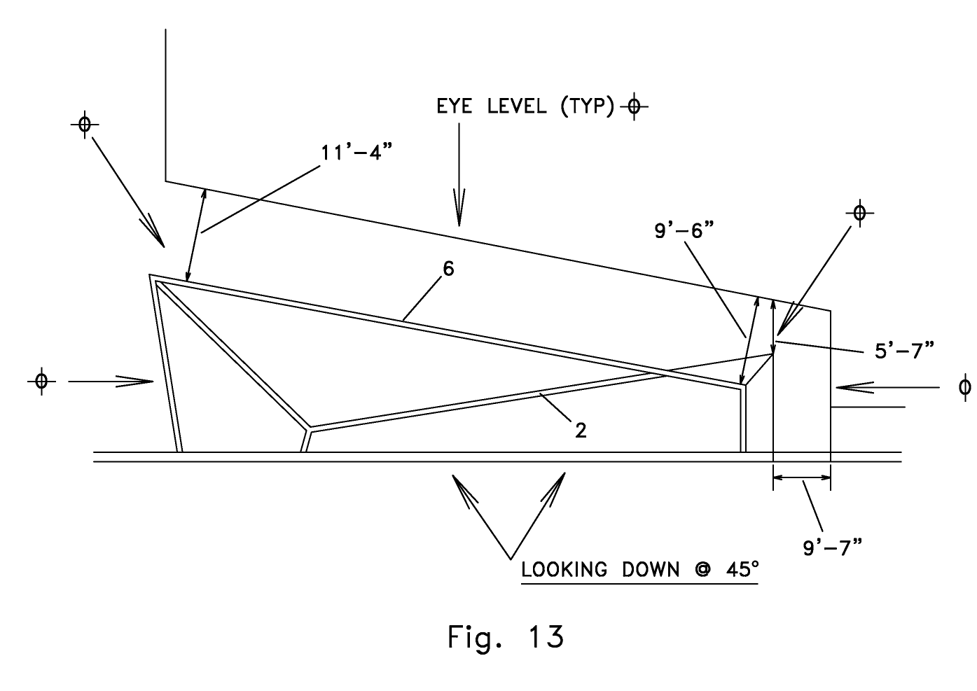

In certain embodiments, the climbing wall structure may be a three faced climbing wall structure (see e.g., FIG. 5). In such, embodiments, the climbing wall structure may have two corners. In certain embodiments where the climbing wall structure has three faces, one of may be a first face (81), a second face (45) may have an overhang (46) adjacent the overhanging prow, and a third face (47) may have a ramp (48) adjacent the ramped corner. Regardless of the number of faces, any face may have a top and bottom plate that at one face end or at the inner-most start of one corner are a certain straight line distance apart, and that at the other face end or at the inner-most start of the other corner are a different straight line distance apart. Such variation in height is one of the many ways the wall structure can be varied. Regardless of such distances, top and bottom plates may be horizontal or sloped independently. Typically, the bottom plate will “follow” the grade of the underlying ground surface (e.g., a floor or ground outside, which may be graded to achieve the desired orientation of the base plate), but not necessarily.

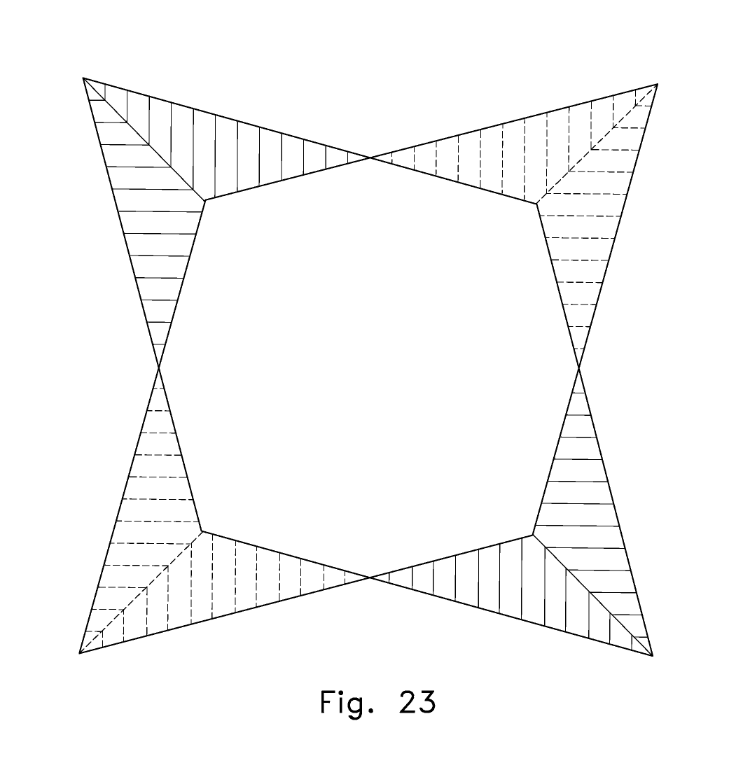

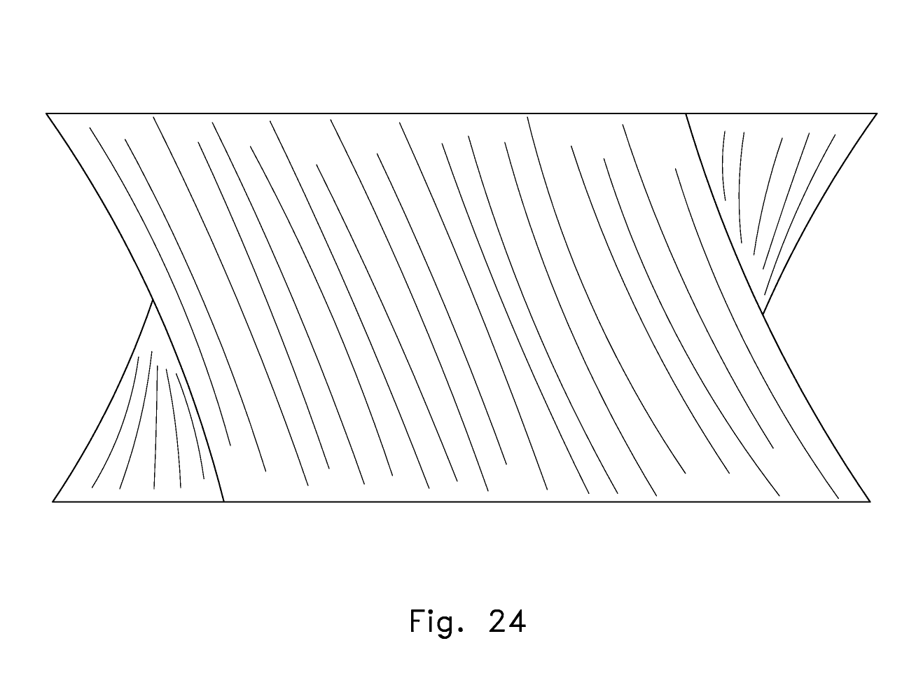

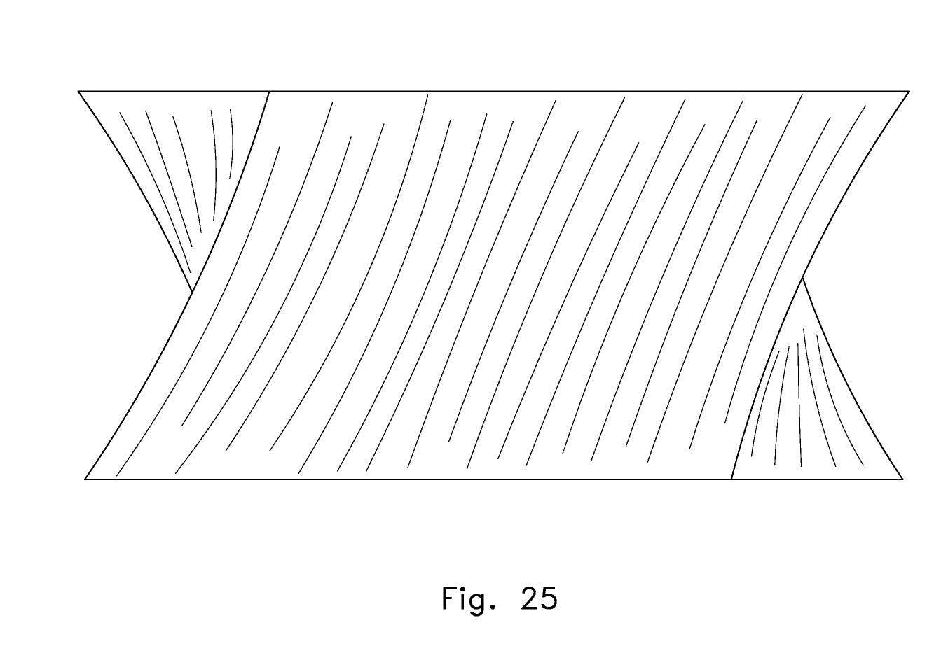

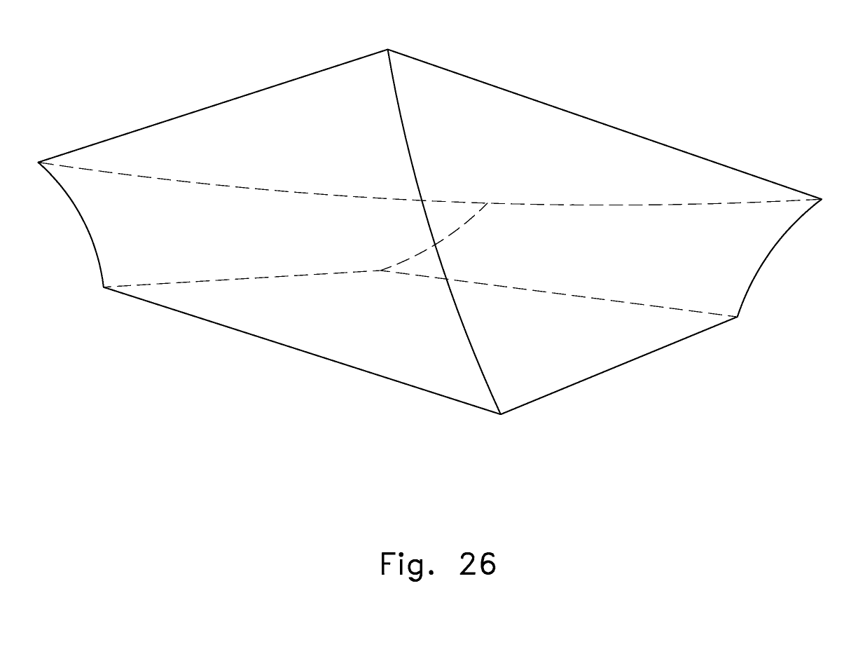

In freestanding embodiments, as where, for example, the climbing wall structure is a four faced climbing wall structure (see e.g., FIGS. 23-26), the climbing wall structure may have four corners (as but one example of a free-standing structure). Of course, a free standing version could have any number of faces (even only 1); in embodiments where opposing walls are not providing support, support could be provided through the use of anchors in the ground behind the wall (technically, this might not be considered a free-standing structure, although it may appear so to a climber). Where available, support in non-freestanding designs may be provided via vertical rods (as but one example) that tie into pre-existing, overhanging supports (e.g., ceiling supports). Freestanding islands typically would require at least 3 faces. It is also of note that certain embodiments need not have any corners (e.g., as where the face is between two vertical, conventionally designed walls).

Where there are corners, such corners each may be either overhanging, vertical, or ramped (or a combination thereof). It is of note that all of the inventive embodiments described with application to climbing may find application in a non-climbing arena (e.g., simply a wall for aesthetic and/or support and/or segregation purposes), of course, without the climbing holds. It is of note that or more of the faces of a multifaced structure (whether free standing or not, whether for climbing or not), may be an inventive wall while other faces may or may not be well known conventional walls (e.g., purely vertical). Such structure, with all such faces, is still considered within the ambit of the inventive technology.

Particular embodiments may have a hyperboloid section shape (the shape of a nuclear power cooling tower). This cooling tower may conceptually be lain on its side, and possibly canted (where one side is lifted higher than the other), a section thereof may form the shape for the wall. Particular embodiments may instead have a hyperbolic paraboloid section shape. Regardless, in any of the inventive walls, faces incorporating the inventive technology may be entirely overhanging, entirely ramped, or have a ramped portion and an overhanging portion and “dead” vertical (particularly in thin (left-to-right) sections). One side (e.g., a right side) of each inventive face will typically be steeper than the other side.

It is of note that typically, a climber climbing straight up the wall (without moving left to right) would not experience a change in the steepness of the wall, but as that climber moves more left or right, he/she would experience a change in steepness (in one example, as the climber moves right, it may get steeper, but as she moves left it gets less steep). As such, such embodiments of the wall may be only similar to ocean waves, which, when “overhanging”, curl in a vertical plane that's orthogonal to the long axis of the wave (analogous to the bottom plate).

It is of note, particularly with regard to climbing wall method (e.g., construction method) embodiments, that the step of securing may be accomplished via fastener or adhesive, for example, and the step of establishing typically includes the step of positioning (e.g., manually, and/or with the use of props and supports), and may also include the step of securing. It is of note that the step of securing a plurality of discrete surface panels may by itself accomplish the step of warping those discrete surface panels. This may result from the fact that the straight support members may be angled relative to adjacent straight support members; when a panel is secured to adjacent straight support members, an intended warping will thus occur.

Certain embodiments of the inventive technology relate to a retrofit washer (50) that can be used to expand the purchase of the t-nut to the back of the paneling upon application of the washer between the paneling and t-nut. Preferably the washer is secured to the substrate (paneling) with screws located at a greater diameter from center than the original t-nut. This washer has an inner washer radius that is slightly greater than the outside radius of the t-nut chamber. The outside radius of the washer can be any size needed to expand the purchase of the t-nut past and outside of the damaged area of the substrate; it typically is greater than the outer radius of the t-nut's annular base. Where there are separate holes for bolt or screw attachment of the washer itself to the substrate, the washer may be preferably attached to the paneling through holes that are radially offset (e.g., at a greater radius) from those holes that are dedicated for attachment of the T-nut alone. In certain embodiments, where the T-nut allows, and the inner radius of the washer is sufficiently small, there may be holes through the washer established in alignment with the holes through the T-nut washer, so that the set of screws used to secure the T-nut in place can also be used to secure the washer in place. However, particularly where the substrate in the area of the central hole through the substrate is frayed or compromised in some way, it may be preferable to secure the washer also with a separate set of bolts or screws, through holes that are not “under” the T-nut when the T-nut is put into position.

As a more concrete example of the wear that T-nuts used in a climbing application experience, in a particular test case, a climbing wall on which climbing holds are installed and removed on a weekly basis to allow for new climbing routs continuously had approximately 1,000 t-nut attachments which became unusable due to the wallow out of the screws and damage to the back of the plywood substrate. Some of these climbing holds were 18″ across and had been bolted to the wall and t-nut with ⅜″ (OD) cap screws. Much twisting force was applied during installation and removal of the climbing holds to the t-nut and its securing 3 screws (located in a ⅜″ diameter from center). To resolve this issue a ½″×2″ (ID×OD) washer was installed behind these standard t-nuts which increased the purchase of the screws to a diameter of ¾″ from center and solved most of the problem at these damaged areas. Several damaged locations required a ½″×4″ washer to expand the purchase to 1¾″. Use of the washer for T-nuts in areas of damage showed improved retention of holds, less movement of the attached hold under an applied load, and appear to withstand the continued twisting force required to attach and remove large climbing holds bolted with large cap bolts through the substrate to the t-nut.

While preferred embodiments of the retrofit washer may have bolt or screw holes in them for direct attachment of the washer to the surface paneling without passing through the annular base of the t-nut, this is not a required feature. However, use of screws to attach the washer directly to the paneling without passing those screws through the annular base of the t-nut (in addition to screws that pass through holes of the washer that are aligned with those of the annular base of the t-nut) may improve overall retention strength of the attached climbing hold or bolt.

Particular embodiments of the inventive technology may be described as a t-nut apparatus (51) that comprises: a t-nut (52) having a chamber (53) with two ends (54, 55), the chamber open at both ends, an outer chamber wall (56) having an outer chamber radius (57), a threaded inner chamber wall (58), and an annular base (59) at one of the chamber ends, the annular base having an outer annular base radius (60) and n number of holes (61) (3, as but one example) therethrough, each sized to accommodate a fastener, the holes established symmetrically at an annular t-nut base hole radius (62). Such t-nut is conventional. However, an inventive annular washer used in conjunction with the conventional t-nut may afford as yet unseen benefits (described above). The annular washer (50) may have an inner washer radius (64) that is greater than the outer chamber radius (57) but smaller than the outer annular base radius (60); an outer washer radius (65) that is greater than the outer annular base radius; and n number of holes (66) through the annular washer at the annular t-nut base hole radius (62), the holes located to align with the holes through the annular base of the t-nut when the annular washer is positioned around the chamber and against the annular base of the t-nut. The apparatus/combination system/kit may further comprise additional holes (67) through the annular washer, the holes established at an outer hole radius (68), and symmetrically at the outer hole radius, the outer hole radius being greater than the outer annular base radius.

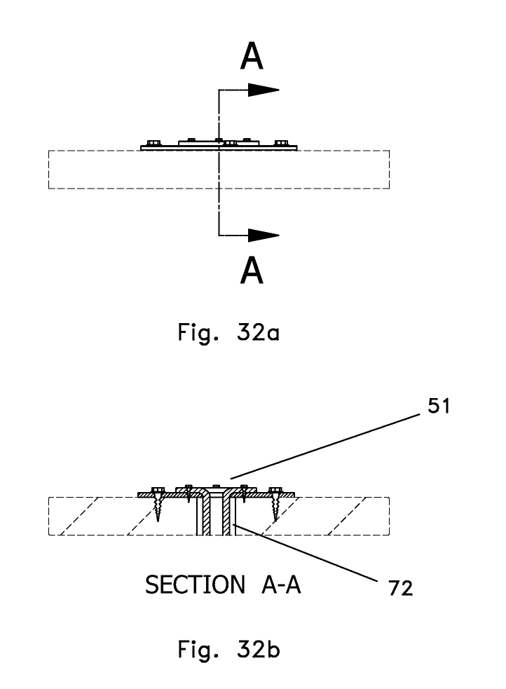

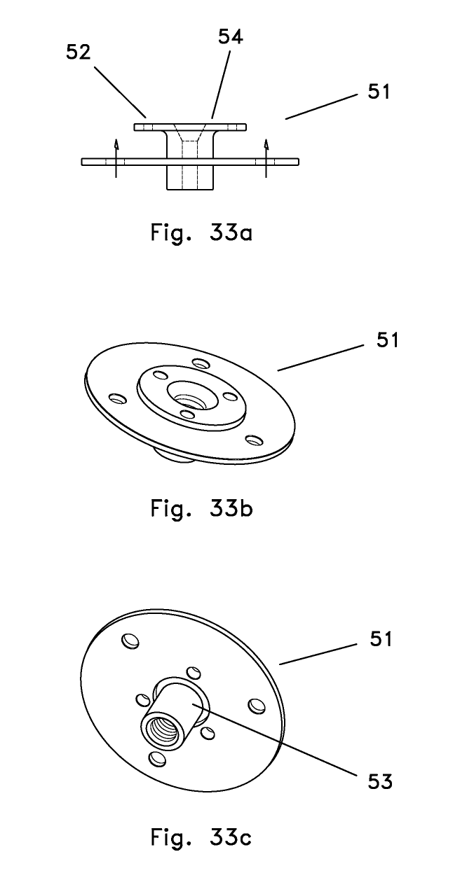

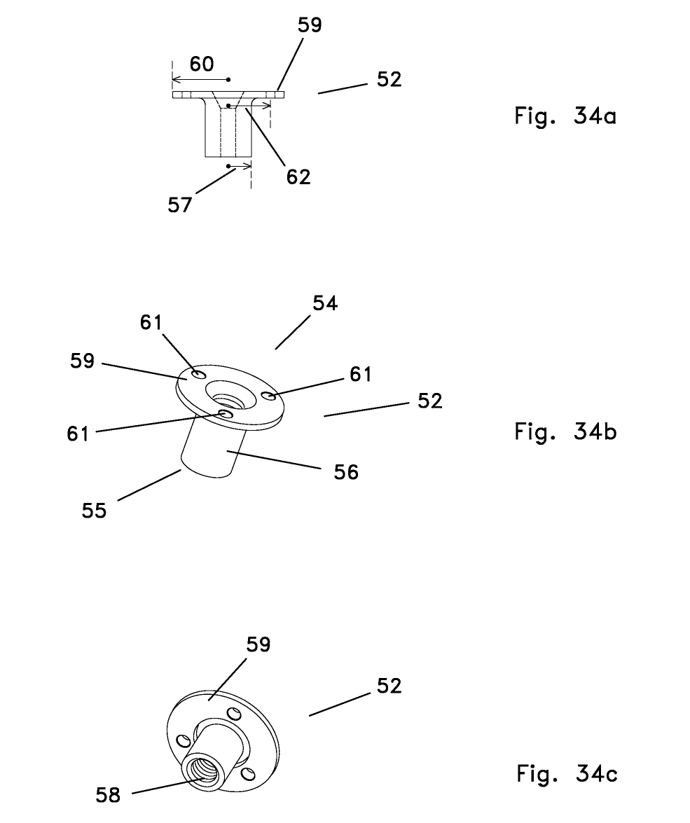

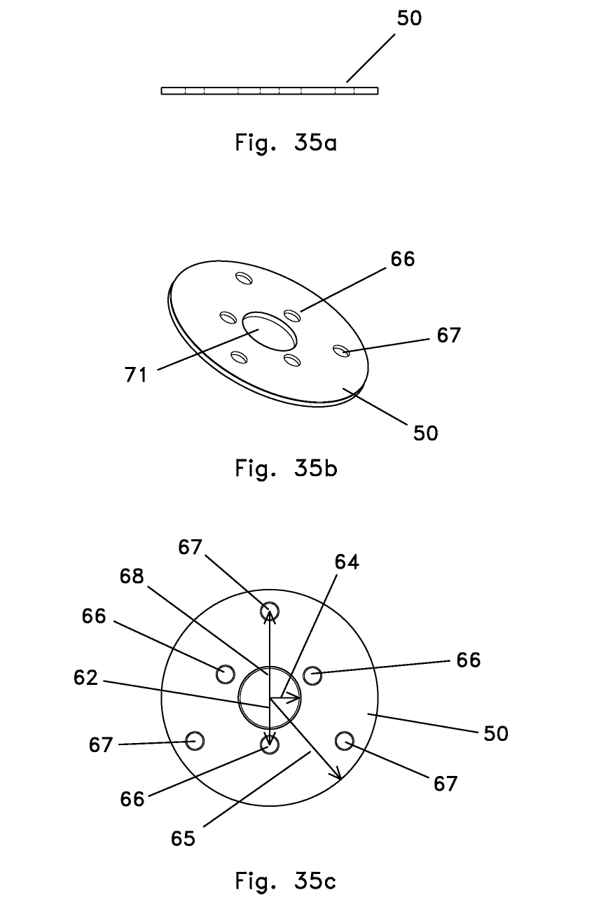

A related method invention may be described as a method for reconditioning “substrate or paneling compromised” t-nut climbing hold attachments on a climbing wall (or preventing such structural compromise) via retrofitting by: removing a climbing hold (70) associated with an original t-nut to be retrofitted; removing the original t-nut from a paneling hole (72) through paneling, the original t-nut passing through the paneling before the step of removing the original t-nut; and positioning a washer against the back side of the paneling, the washer having a central washer hole (71). The step of positioning the washer may comprise the step of aligning the central washer hole with the paneling hole, the washer having holes therethrough. The retrofit method may further comprise the step of positioning a replacement T-nut through the central washer hole and the paneling hole, the replacement t-nut having an annular base with holes therethrough, the step of positioning a replacement T-nut comprising the step of position the replacement t-nut so that the washer is between the annular base of the replacement t-nut and the paneling (see FIG. 32B, e.g.); and securing the washer in place against the paneling with fasteners that pass through holes through the washer, the holes aligned with holes that are through the annular base of the replacement t-nut. The method may further comprise the step of securing the washer in place against the paneling through the use of fasteners that pass through holes (67) that are through the washer but not through the annular base of the replacement t-nut. It is of note that the replacement t-nut may be a new t-nut, may be the original t-nut, or may be a used t-nut that is different from the original t-nut. A final step may be passing a bolt through the t-nut and a climbing hold (whether the original or a replacement hold).

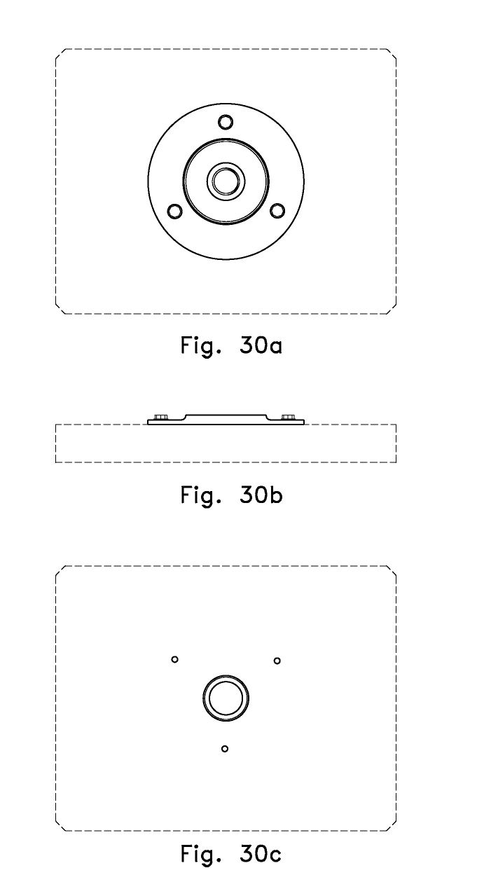

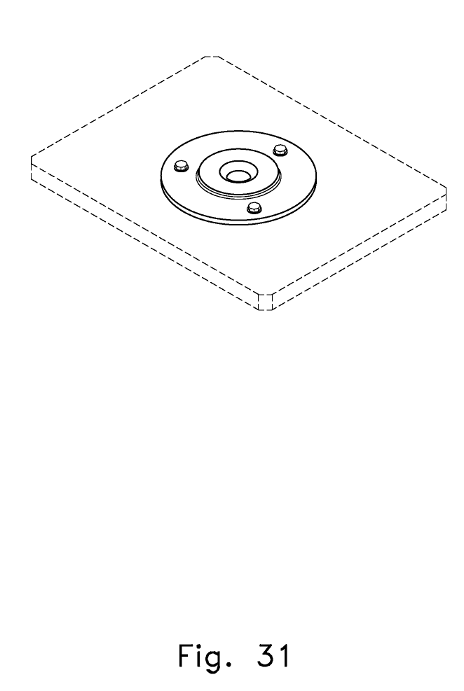

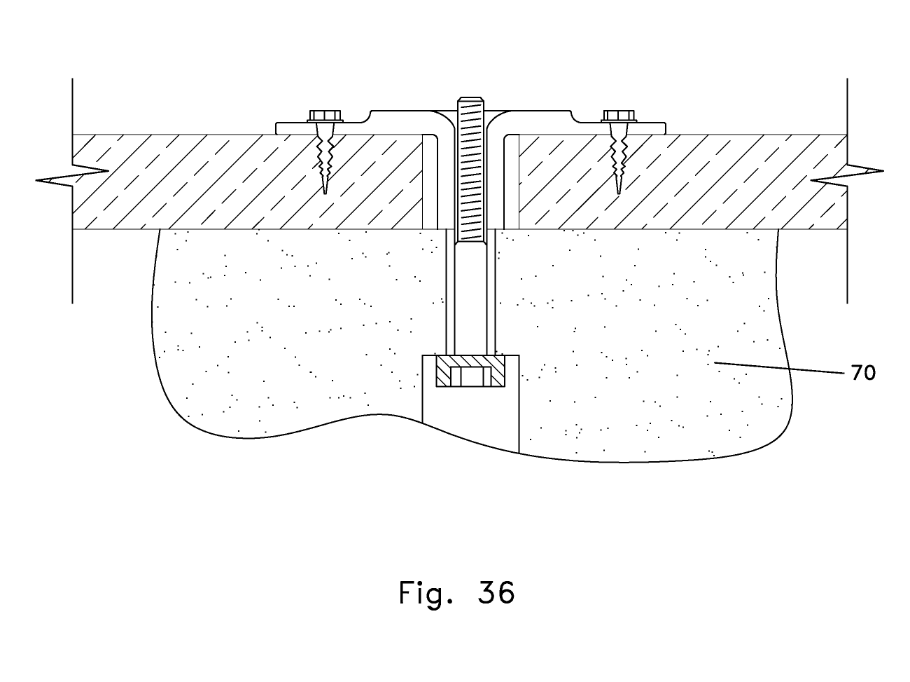

The inventive technology also includes a T-nut that has expanded annular base. While it can be used to replace conventional T-nuts, it is not a retrofit (i.e., it is not to be used in close conjunction with an existing t-nut). It may be said that this inventive T-nut has a built-in washer. Such an expanded t-nut can be manufactured with the shaft and threads integral with an expanded washer of any size. On such T-nuts, it may not be necessary to have a set of screw holes for the T-nut and a separate set of screw holes for the washer. Indeed, only one set (e.g., 3 holes, each a certain distance from the T-nut's central hole) may be necessary. It may prove advantageous if such holes are established further from the central hole than found in conventional T-nuts. The outer annular base radius, in this inventive t-nut, is greater than the outer annular base radius seen in conventional t-nuts. Exemplary embodiments appear in FIGS. 30A-C, FIG. 31, and FIG. 36.

As can be easily understood from the foregoing, the basic concepts of the present invention may be embodied in a variety of ways. It involves both T-nut attachment and wall construction techniques as well as devices to accomplish the appropriate attachment and construction. In this application, the T-nut attachment techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “bolt” should be understood to encompass disclosure of the act of “bolting”—whether explicitly discussed or not—and, conversely, were there effectively disclosure of the act of “bolting”, such a disclosure should be understood to encompass disclosure of a “bolt” and even a “means for bolting” Such changes and alternative terms are to be understood to be explicitly included in the description.

Any acts of law, statutes, regulations, or rules mentioned in this application for patent; or patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Provisional Patent Application or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the t-nut related devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 20 or any other claim” or the like, it could be re-drafted as dependent on claim 1, claim 15, or even claim 25 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1. A climbing wall structure, comprising:
a bottom plate that is straight and has a bottom plate projection in a horizontal plane;
a top plate that is straight and has an top plate projection in said horizontal plane;
a first face substantially between said bottom plate and said top plate,
wherein said bottom plate projection in said horizontal plane is angled relative to said top plate projection in said horizontal plane,
a plurality of straight support members, a majority of which extending from said bottom plate to said top plate, each of said plurality of straight support members attached at a lower support member end thereof to said bottom plate and to said top plate at an upper support member end thereof, said straight support members each having an outer edge;
a climbing hold support surface of said first face that includes a plurality of discrete, warped surface panels, said discrete, warped surface panels attached to said straight support members, said discrete warped surface panels being planar before attachment to said straight support members, said discrete, warped surface panels each having an upper, lower, right and left edge portion, each of a majority of said discrete, warped surface panels attached to two different of said straight support members at said right edge portion and said left edge portion of said discrete, warped surface panel;
wherein each of a lower portion of said discrete, warped surface panels are attached to said bottom plate at said lower edge portions of said lower portion of said discrete, warped surface panels;
wherein each of an upper portion of said discrete, warped surface panels are attached to said top plate at said upper edge portions of said upper portion of said discrete, warped surface panels;
climbing holds attached to said climbing hold support surface;
two corners at a left and right end of said first face, at least one of which is an overhanging prow at a first corner side of said first face, said overhanging prow having a straight overhanging prow projection in said horizontal plane, and having a curved profile when viewed by a climber standing centrally in front of said first face,
wherein said straight overhanging prow projection defines an obtuse angle relative to said bottom plate projection, said obtuse angle having a overhanging prow projection angle vertex,
wherein at least one of said two corners is a ramped corner at a second corner side of said first face, said ramped corner having a straight ramped corner projection in said horizontal plane,
wherein said bottom plate projection intersects with said top plate projection, said intersection defining a vertical wall portion of said first face,
a ramped portion of said climbing wall structure on one side of said vertical wall portion and an overhanging portion of said climbing wall structure on the other side of said thin vertical wall portion,
wherein said plurality of straight support members are progressively longer from said vertical wall portion to a wall portion corresponding to said overhanging prow projection angle vertex,
wherein a straight line connecting a point on said ramped corner that is X percent up from said bottom plate to a point on said overhanging prow that is said X percent up from said bottom plate contacts said climbing hold support surface of said first face at all points on said straight line,
wherein projections in a vertical plane that is orthogonal to said bottom plate projection, of said left and right edge portions of a each of a majority of said plurality of said discrete, warped surface panels are angled relative to each other, and
wherein projections in said horizontal plane, of said upper and lower edge portions of a each of a majority of said plurality of said discrete, warped surface sheathing materials are angled relative to each other.

2. A climbing wall structure as described in claim 1 wherein projections in said vertical plane of a majority of said straight support members are angled relative to each other.

3. A climbing wall structure as described in claim 1 wherein projections in a vertical plane that is parallel to said bottom plate of a majority of said plurality of straight support members are parallel.

4. A climbing wall structure as described in claim 1 wherein a majority of said plurality of straight support members are spaced a substantially equal distance.

5. A climbing wall structure as described in claim 4 wherein said substantially equal distance is a surface panel width.

6. A climbing wall structure as described in claim 1 wherein said climbing wall structure is a three faced climbing wall structure.

7. A climbing wall structure as described in claim 6 wherein said climbing wall structure has two corners.

8. A climbing wall structure as described in claim 6 wherein said climbing wall structure has three faces, one of which is said first face, a second of which has an overhang adjacent said overhanging prow, and a third of which has a ramp adjacent said ramped corner.

9. A climbing wall structure as described in claim 1 wherein said climbing wall structure is a four faced climbing wall structure.

10. A climbing wall structure as described in claim 9 wherein said climbing wall structure has four corners.

11. A climbing wall structure as described in claim 9 wherein said climbing wall structure is free standing.

12. A climbing wall structure as described in claim 1 wherein said climbing wall structure is a free standing climbing wall structure.

13. A climbing wall structure as described in claim 12 wherein said climbing wall structure comprises at least four faces.

14. A climbing wall structure as described in claim 12 wherein said climbing wall structure comprises at least four corners.

15. A climbing wall structure as described in claim 1 wherein said curved profile of said overhanging prow is a circular arc profile.

16. A climbing wall structure as described in claim 15 wherein a nominal center of said curved profile is lower than any point on said bottom plate.

17. A climbing wall structure as described in claim 1 wherein projections of a majority of said plurality of straight support members onto said vertical plane that is parallel said bottom plate form a 90 degree angle with said bottom plate.

18. A method for constructing a climbing wall, comprising the steps of:
securing a bottom plate to a underlying ground structure;
establishing a top plate above said bottom plate;
securing a plurality of straight support members to at least one of said plates;
wherein all of said straight support members each having an outer edge when secured;
securing corner supports at a right and left end of a first face of said climbing wall and to said bottom plate and said top plate;
securing a plurality of discrete surface panels to said outer edges of said plurality of straight support members to construct a climbing hold support surface, said discrete surface panels secured at right and left edge portions thereof;
warping said plurality of discrete surface panels while performing said step of securing a plurality of discrete surface panels; and
attaching climbing holds to said climbing hold support surface,
wherein said bottom plate has a bottom plate projection in a horizontal plane;
wherein said top plate has an top plate projection in said horizontal plane;
wherein said bottom plate projection in said horizontal plane is angled relative to said top plate projection in said horizontal plane,
wherein at least at least one of said corners is an overhanging prow at a first corner side of said first face, said overhanging prow having a straight overhanging prow projection in said horizontal plane, and having a curved profile when viewed by a climber standing centrally in front of said first face,
wherein said straight overhanging prow projection defines an obtuse angle relative to said bottom plate projection, said obtuse angle having a overhanging prow projection angle vertex,
wherein at least one of said at least two corners is a ramped corner at a second corner side of said first wall, said ramped corner having a straight ramped corner projection in said horizontal plane,
wherein said bottom plate projection intersects with said top plate projection, said intersection corresponding to a vertical wall portion of said main wall,
wherein said step of securing a plurality of discrete surface panels to said outer edges of said plurality of straight support members comprises the steps of forming a ramped portion of said climbing wall structure on one side of said vertical wall portion and forming an overhanging portion of said climbing wall structure on the other side of said vertical wall portion,
wherein said plurality of straight support members are progressively longer from said vertical wall portion to a wall portion corresponding to said overhanging prow projection angle vertex,
wherein a straight line connecting a point on said ramped corner that is X percent up from said bottom plate to a point on said overhanging prow that is said X percent up from said bottom plate contacts said climbing hold support surface of said first wall at all points on said straight line,
wherein projections in a vertical plane that is orthogonal to said bottom plate, of said left and right edge portions of a each of a majority of said plurality of said discrete surface panels are angled relative to each other, and
wherein projections in said horizontal plane, of said upper and lower edge portions of each of a majority of said plurality of said discrete surface panels, when secured, are angled relative to each other.

19. A method for constructing a climbing wall as described in claim 18 wherein projections in said vertical plane that is orthogonal to said bottom plate of a majority of said straight support members are angled relative to each other.

20. A method for constructing a climbing wall as described in claim 18 wherein projections in a vertical plane that is parallel to said bottom plate of a majority of said plurality of straight support members are parallel.

21. A method for constructing a climbing wall as described in claim 18 wherein a majority of said plurality of straight support members are spaced a substantially equal distance.

22. A method for constructing a climbing wall as described in claim 18 wherein said climbing wall structure is a three faced climbing wall structure, each of said faces having a different aspect.

23. A method for constructing a climbing wall as described in claim 22 wherein said climbing wall structure has two corners.

24. A method for constructing a climbing wall as described in claim 22 wherein said climbing wall structure has three climbing faces, one of which is said first face, a second of which has an overhanging adjacent said overhanging prow, and a third of which has a ramp adjacent said ramped corner.

25. A method for constructing a climbing wall as described in claim 18 wherein said climbing wall structure is a four faced climbing wall structure.

26. A method for constructing a climbing wall as described in claim 25 wherein said climbing wall structure has four corners.

27. A method for constructing a climbing wall as described in claim 25 wherein said climbing wall structure is free standing.

28. A method for constructing a climbing wall as described in claim 18 wherein said climbing wall structure is a free standing climbing wall structure.

29. A method for constructing a climbing wall as described in claim 28 wherein said climbing wall structure comprises at least four faces.

30. A method for constructing a climbing wall as described in claim 28 wherein said climbing wall structure comprises at least four corners.

31. A method for constructing a climbing wall as described in claim 18 wherein said curved profile of said overhanging prow is a circular arc profile.

32. A method for constructing a climbing wall as described in claim 31 wherein a nominal center of said curved profile is below said bottom plate.

33. A method for constructing a climbing wall as described in claim 18 wherein projections of a majority of said plurality of straight support members onto said vertical plane that is parallel said bottom plate form a 90 degree angle with said bottom plate.

34-44. (canceled)
